(19) United States
(12) Patent Application Publication
(10) Pub. No.: US 2024/0149223 A1
(43) Pub. Date: May 9, 2024

(54) MEMBRANE DEVICE

(71) Applicant: EVOVE LTD, Manchester (GB)

(72) Inventors: Kangsheng LIU, Manchester (GB); Tom PUGH, Manchester (GB); Tristan PHILIPS, Manchester (GB)

(21) Appl. No.: 18/280,855

(22) PCT Filed: Mar. 10, 2022
(86) PCT No.: PCT/GB22/50622

§ 371 Date: Sep. 7, 2023

(30) Foreign Application Priority Data
Mar. 10, 2021 (GB) 2103326.1

(51) Int. Cl. B01D 69/10; C02F 1/44; C04B 38/00

(52) U.S. Cl. CPC B01D 69/108; C02F 1/44; C04B 38/0054; C04B 38/007; C04B 38/0096

(57) ABSTRACT

A membrane device comprising a porous ceramic member. The porous ceramic member comprises a first support portion operable to support an active layer and further comprises a second support portion. The second support portion has a higher D₇₅ average pore size than the D₇₅ average pore size of the first support portion. The second support portion comprises a lattice structure that has a porosity percentage of ≥40%. The porous ceramic member has a tensile strength operable to withstand feed application pressure of ≥100 kPa (1 bar).

### FIELD

The present invention relates to membrane devices. More specifically, ceramic membrane devices obtained by additive manufacturing for water purification.

### BACKGROUND

Conventional methods of water treatment such as chemical disinfection, solar disinfection, boiling, sedimentation and distillation are not sufficient to meet portable water requirement of the world's population at low cost. In order to tackle the problem, more advanced technologies have been established and industrialised, such as pressure driven membrane-based water treatment technologies which in general include ultrafiltration (UF), microfiltration (MF), nanofiltration (NF), and reverse osmosis (RO). By providing the advantages of circumventing the application of thermal inputs, chemical additives and reducing medium regeneration, these methods have significantly improved water treatment industry. However, is it still desirable to provide functional membranes with further improved properties such as high sieving electivity, low energy cost, and higher water flux rate for sustainable water treatment and modern water treatment industry.

Membrane filtration is favoured over other water treatment technologies due to, in principle, no significant thermal input, fewer chemical additives and a lower requirement for the regeneration of spent media. Pressure-driven membrane processes are the most widely applied membrane technologies in water treatment, for the removal of particulates, ions, microorganisms, bacteria and natural organic materials, covering different applications from wastewater treatment from the food and oil industry to seawater desalination.

Typically, separation membranes are categorised in accordance with the characteristic pore size or intended applications. Microfiltration membranes (MF), with pore sizes in a range of 0.1 μm to 100 μm, can be used to remove bacteria, cysts, yeast cells, suspending particles, pigments, and asbestos. Ultrafiltration membranes (UF), having pore sizes in a range of 0.01 μm and 0.1 μm, can be used to remove proteins, colloidal particles and viruses. Nanofiltration membranes (NF), with pore sizes in the range of from 0.001 to 0.01 μm, can be used to select multivalent ions, dissolved compounds, medium sized organic molecules, small proteins, small colloidal particles. Reverse osmosis membranes (RO), with pore sizes smaller than 0.001 μm, can be used to remove ions and small organic molecules.

Currently, the commercially available separation membranes perform well in a wide range of applications; however, the drive to produce new clean water resources and protect existing water resources at lower capital and operating costs demands more advanced membranes having properties including improved and tuneable fouling resistance, size exclusion, higher selectivity, higher productivity at lower energy inputs, longer life span, improved chemical and mechanical resistance and fewer manufacturing defects. Accordingly, new materials, membrane systems and processing technologies having properties to fulfil the demands are desired.

Nanoporous materials may have application in water separation membranes, however, the use of such materials presents challenges in relation to scalability, mechanical strength, chemical robustness, life span, dissolution in liquid media, as well as the high cost of the materials and of the subsequent manufacturing processes required for their incorporation. Therefore, there is a requirement for improved membranes for separation, in particular for water treatment applications.

Membranes are normally made from a certain thickness of material in order to have enough mechanical properties to be used in an application. However, thinner membranes use less material in manufacture and can improve flux. Therefore, there is a need for a balance between these properties to produce a membrane that provides good separation.

It is therefore an object of aspects of the present invention to address one or more of the above mentioned or other problems.

### SUMMARY

According to a first aspect of the present invention, there is provided a membrane device comprising a porous ceramic member, wherein the porous ceramic member comprises a first support portion operable to support an active layer and further comprises a second support portion, wherein the second support portion has a higher D₇₅ average pore size than the D₇₅ average pore size of the first support portion, wherein the second support portion comprises a lattice structure that has a porosity percentage of ≥40%, and wherein the porous ceramic member has a tensile strength operable to withstand feed application pressure of ≥100 kPa (1 bar).

According to a second aspect of the present invention, there is provided a membrane device comprising a porous ceramic member, wherein the porous ceramic member is obtained by additive manufacture, and wherein the porous ceramic member comprises a first support portion operable to support an active layer and further comprises a second support, wherein the second support portion has a higher D₇₅ average pore size than the D₇₅ average pore size of the first support portion, wherein the second support portion comprises a lattice structure that has a porosity percentage of ≥40%, and wherein the porous ceramic member has a tensile strength operable to withstand feed application pressure of ≥100 kPa (1 bar).

According to a third aspect of the present invention, there is provided a water-treatment membrane device comprising a porous ceramic member, wherein the porous ceramic member comprises a first support portion operable to support an active layer and further comprises a second support, wherein the second support portion has a higher D₇₅ average pore size than the D₇₅ average pore size of the first support portion, wherein the second support portion comprises a lattice structure that has a porosity percentage of ≥40%, and wherein the porous ceramic member has a tensile strength operable to withstand feed application pressure of ≥100 kPa (1 bar).

According to a fourth aspect of the present invention, there is provided a method of preparing a membrane device comprising a porous ceramic member, wherein the porous ceramic member comprises a first support portion operable to support an active layer and further comprises a second support, wherein the second support portion has a higher D₇₅ average pore size than the D₇₅ average pore size of the first support portion, wherein the second support portion comprises a lattice structure that has a porosity percentage of ≥40%, and wherein the porous ceramic member has a tensile strength operable to withstand feed application pressure of ≥100 kPa (1 bar), the method comprising the steps of:
a. additively manufacturing the porous ceramic member to produce the lattice structure of the second support portion and form the first support portion;
b. optionally, removing binder from the first support portion to form pores in the first support portion;
c. optionally, applying an active layer to at least a portion of the first support portion, suitably by coating an active layer composition onto the first support portion.

Advantageously, the membrane device of the present invention provides a thinner porous ceramic member, which may provide and/or support a membrane/active layer mechanically during the manufacturing process and in the final filter application while creating desirable fluid dynamic properties and allowing a greater packing density. The results provided by the present invention may maintain a high porosity so as to not restrict fluid flow in the final filter application.

The membrane device may further comprise an active layer supported on the porous ceramic member, specifically, wherein the active layer extends across at least a portion of the first support portion. The application of an active layer may increase the selectivity of the filtration.

In the present invention, the membrane walls may be thinner due to the additively manufactured porous ceramic lattice structure which allows increased packing density of membrane structures, creating more active surface area within the membrane. Thinner membrane walls also lead to less dead-end pores and a less tortuous pathway, increasing flux across the membrane.

The first support portion may have an average thickness of 0 μm, such as ≥20 μm, ≥30 μm, ≥40 μm, such as 50 μm.

The first support portion may have an average thickness of ≤1000 μm, such as ≤800 μm, ≤600 μm, ≤400 μm, such as ≤200 μm.

The first support portion may have an average thickness of from between 10 μm to 1000 μm, such as from 20 to 800 μm or from 30 to 600 μm, such as 40 to 400 μm or 50 to 200 μm, such as 50 to 150 μm or 50 to 100 μm. The first support portion as referred to herein, may refer to a ceramic surface between the feed inlet side and the permeate outlet side.

The second support portion may be operable to produce substantially laminar flow towards a permeate collection point.

The second support portion may comprise turbulent flow paths. Advantageously, this allows better homogenisation of fluid content.

The membrane device of the present invention may comprise a feed flow channel, suitably a plurality of feed flow channels, such as a plurality of substantially linear, and optionally substantially parallel feed flow channels. The feed flow channel may be substantially cylindrical.

The average width/diameter of the feed flow channel may be ≥0.1 mm, such as ≥0.3 mm or ≥0.5 mm. The “width” in the present context is intended to mean the largest lateral dimension of the channel. The average width/diameter of the feed flow channel may be ≤10 mm, such as ≤7 mm or ≤5 mm. The average width/diameter of the feed flow channel may be from 0.1 to 10 mm, such as from 0.3 to 7 mm or from 0.5 to 5 mm.

The membrane device may comprise at least two feed flow channels that are spaced along at least a portion of their lengths by the first and second support portions, for example spaced by two first support portions with a second support portion arranged between the two first support portions.

The at least two spaced feed flow channels may be spaced by ≤4mm measured from the narrowest points between two adjacent flow channels, such as ≤3 mm, or ≤2 mm.

The at least two spaced feed flow channels may be spaced by≥0.03 mm measured from the narrowest points between two adjacent flow channels, such as ≥0.06 mm or ≥0.09 mm.

The at least two spaced feed flow channels may be spaced by from 0.03 mm to 4 mm measured from the narrowest points between two adjacent flow channels, such as from 0.06 mm to 3 mm, or from 0.9 mm to 2 mm.

The average distance between the narrowest points of adjacent flow channels in the membrane device may be ≤4 mm measured from the narrowest points between two adjacent flow channels, such as ≤3 mm, or ≤2 mm.

The average distance between the narrowest points of adjacent flow channels in the membrane device may be ≥0.03 mm measured from the narrowest points between two adjacent flow channels, such as ≥0.06 mm or ≥0.9 mm.

The average distance between the narrowest points of adjacent flow channels in the membrane device may be from 0.03 mm to 4 mm measured from the narrowest points between two adjacent flow channels, such as from 0.06 mm to 3 mm, or from 0.09 mm to 2 mm.

The membrane device may comprise a channel pitch, such an average pitch, of ≤14 mm, such as ≤10 mm or ≤7 mm.

The membrane device may comprise a channel pitch, such an average pitch, of ≥0.13 mm, such as ≥0.36 mm or ≥0.59 mm.

The membrane device may comprise a channel pitch, such an average pitch, of from 0.13 mm to 14 mm, such as from 0.36 mm to 10 mm or from 0.59 to 7 mm.

As used herein, “channel pitch” refers to the distance between two adjacent feed channels as measured from the centre points of the feed channels.

The membrane device may have a membrane packing density, such as an active layer packing density, of ≥200 m²/m³, such as ≥350 m²/m³, such as ≥500 m²/m³.

Packing density may be calculated by any suitable method known to the skilled person. In general terms:

$$Packing density = \frac{membrane surface area}{Filter volume}$$

For example, when the membrane device comprises cylindrical feed flow channels that packing density may be calculated as follows;

Dimensional measurements are made of:
r_{c}=Single channel radius
L=Channel length
r_{f}=Ceramic filter radius
L_{f}=Ceramic filter length

C=2×π×r_{c}

V=L_{ƒ}×π×r_{ƒ}²
C=Channel Circumference
L_{c}=Channel length
N=number of channels
V=ceramic filter volume

$$Packing density = \frac{N \times C \times {L}_{c}}{V}$$

The membrane device may comprise ≥3 feed flow channels, such as ≥5 or ≥10 feed flow channels. The feed flow channels may be interconnected such that feed can flow into another feed flow channel or may be discrete such that feed is not operable to flow into another feed flow channel

The feed flow channel may extend into the porous ceramic member, suitably extend through the porous ceramic member, such as from one side of the porous ceramic member/membrane device to a substantially opposed side of the member/device. The channel may be a cylindrical channel.

The flow channel may be integrally formed with the first and second support portions. The flow channel may comprise a channel wall formed at least partially of the first support portion, which may optionally comprise an active layer arranged at least partially thereon the internal surface of the channel. The feed flow channel wall may be substantially formed by the first support member, optionally with an active layer arranged at least partially thereover. Feed flowing through the channel may be operable to pass through the optional active layer and the first support portion to thereby be filtered and form permeate flow through the second support portion and then flow out of the porous ceramic member to a permeate collection point. The second support portion may be shelled to provide a secondary permeate flow path through the porous ceramic member to the permeate collection point.

A “lattice structure” as referred to herein, means a three-dimensional structure composing one or more repeating unit cells, wherein the cells are interconnected such as to allow for fluid flow to adjacent cells. Triply period surfaces are included as part of the term “lattice”.

The lattice structure may comprise a unit cell that has a unit cell size of ≥0.01 mm, such as ≥0.1 mm, or ≥0.25 mm.

The lattice structure may comprise a unit cell that has a unit cell size of ≤10 mm, such as ≤7 mm, or ≤5 mm.

The lattice structure may comprise a unit cell having a diamond structure, a cubic structure, a fluorite structure, an octet structure, a Kelvin cell structure, an iso-truss structure, a hex prism diamond structure, a truncated tube structure, a truncated octahedron structure, a Weaire-Phelan structure, a body centred cubic structure, and/or a face centred cubic structure. Optionally, the lattice structure may comprise a unit cell having a TPMS structure selected from a gyroid structure, a schwarz P structure, a schwarz D structure, a schwarz CLP structure, a schwarz H structure, a splitP structure, a neovius structure, or a double gyroid structure.

The second support portion may comprise a non-uniform lattice structure. Non-uniform lattice refers to a lattice structure where one or more type of unit cell is different from another type of unit cell in the overall lattice structure.

Lattice non-uniformity may arise due to one or more different structural features. For example, a difference in the thickness of the lattice struts; a difference in the void space of the lattice unit cells; and/or a difference in the shape of the lattice unit cells.

The non-uniform lattice may comprise a gyroid structure with a gradient, suitably a linear gradient, changing bias length; a gyroid structure with (linear) gradient changing wall thickness; and/or a diamond lattice structure with (linear) gradient changing strut thickness.

The porous ceramic member may have a tensile strength operable to withstand feed application pressure of ≥0.5 MPa, such as ≥1 MPa or ≥2 MPa, optionally, in the range of 2 MPa to 200 GPa.

As used herein, “operable to withstand feed application pressure” means that the porous ceramic member is operable to substantially function as required in the membrane device at the given pressure substantially without damage to the structure of the porous ceramic member. As used herein, tensile strength was measured using a 3-point bend test.

A non-uniform lattice may comprise different lattice cell shapes.

When the second support portion comprises a non-uniform lattice structure, the average thickness of the second support portion may be from between 10 to 2000 μm.

Advantageously, a non-uniform lattice can be thicker in only the areas which require strength, thus reducing the amount of material used. The thickness also has a direct impact on the porosity, with thicker areas having a lower porosity and thinner areas a higher porosity. A higher porosity means more area for liquid to move through, increasing the flux, so having only thickening areas where required, means higher porosity in the overall porous ceramic member.

The lattice unit cell may be shelled to form an internal hollow structure. At least a portion of the internal structure may form a series of interconnected voids with other shelled unit cells. This internal series of interconnected voids may be operable to provide a further conduit for the permeate to pass through. Advantageously, the interconnecting voids increase the overall porosity of the support portion while maintaining the required strength. The interconnecting voids may increase the porosity of the second support portion by about 5 to 15%, such as an increase in porosity of 10%. Suitably, the second support portion may have a porosity percentage of ≥45%, such as ≥50%, or ≥55%. The internal interconnected voids further add to the reduction of material used in the manufacturing of the membrane device, reducing the weight and cost.

The porous ceramic member, the first support portion and/or the second support portion may be formed from a composition comprising a ceramic material that may comprise alumina, titania, zirconia, silicon carbide, hydroxyapatite, silicates, zeolite, metal oxides, or combinations thereof. The ceramic material may comprise alumina, titania, zirconia, silicon carbide, hydroxyapatite, silicates, zeolite, metal oxides, or combinations thereof. The first and second support portions comprise the same or different ceramic material.

The composition may comprise further additives. For example, the composition may comprise a pore forming agent (PFA), such as wheat particles, starch, PMMA, poppy seed and saw dust, a functionalising agent, a nano-material, a metal-organic framework and/or a two dimensional material such as a transition metal dichalcogenide and/or graphene oxide.

The second support portion may have any suitable D₇₅ average pore size. Preferably, the second support portion may be macroporous. The D₇₅ average pore size of the second support portion may be ≥0.1 mm, such as ≥0.2 mm, such as ≥0.3 mm, such as ≥0.4 mm. The D₇₅ average pore size of the second support portion may be ≤5 mm, such as ≤4 mm, such as ≤3 mm, such as ≤2 mm, such as ≤1 mm. The D₇₅ average pore size of the second support portion may be from about 0.1 to 5 mm, such as from about 0.2 to 4 mm, such as about 0.3 to 3 mm, such as about 0.4 to 1 mm.

The first support portion may have any suitable D₇₅ average pore size. The D₇₅ average pore size of the first support portion may be dictated by the components of the ceramic composition used, and the process of sintering the ceramic composition. The D₇₅ average pore size of the first support portion may be from 0.05 to 20 μm depending on application. For example, the first support portion D₇₅ average pore size may change depending on whether the application relates to particle-filtration, micro-filtration, nano-filtration, and reverse osmosis-filtration. The first support portion may typically be microporous. Typically, the D₇₅ average pore size of the first support portion may be ≥1 μm, such as ≥2 μm, such as ≥3 μm, such as ≥5 μm. The D₇₅ average pore size of the first support portion may be ≤20 μm, such as ≤15 μm, such as ≤10 μm. The D₇₅ average pore size of the first support portion may be from about 1 to 20 μm, such as about 2 to 15 μm, or about 3 to 10 μm.

The D₇₅ average pore size may be measured according to methods well known to the skilled person, such as by mercury intrusion porosimetry.

The first support portion may have a porosity percentage of ≥5%, such as ≥10%, such as ≥15% porosity. The first support portion may have a porosity percentage of ≤50%, such as ≤40%, typically, ≤35% porosity. The first support portion may have a porosity percentage of between about 5 to 50%, such as 10 to 40%, such as 15 to 35% porosity.

The second support portion may have a porosity percentage of ≥45%, such as ≥50%, such as ≥55%, such as ≥60%. The second support portion may have a porosity percentage of ≤80%, such as ≤75%, such as ≤70%. The second support portion may have a porosity percentage of between about 40 to 80%, preferably, about 60 to 80%, such as 70% porosity

The porosity is a measurement of the void space of a structure wherein the solid volume of the structure is divided by the total volume occupied dimensionally by the structure, expressed as a percentage.

$$n = ( 1 - \frac{{V}_{S}}{{V}_{T}} ) \times 100$$

where Vₛ is the soild and V_{T} is the total volume.

The first and second support portions may be integrally formed so as to form a continuous structure. Suitably, the first and second support portions are integrally formed by additive manufacturing.

The active layer may have a lamellar structure comprising at least two layers of two-dimensional material, wherein the two-dimensional material comprises a transition metal dichalcogenide (TMD) and/or graphene or a derivative thereof.

The transition metal dichalcogenide may be according to formula (I)

MₐX_{b}, (I)

wherein with M is a transition metal atom, such as Mo, W, Nb and Ni;
X is a chalcogen atom, preferably S, Se, or Te;
wherein 0<a≤1 and 0<b≤2.

The transition metal dichalcogenide may be selected from one or more of MoS₂, MoSe₂, WS₂, WSe₂, MoₐW₁₋ₐS₂, MoₐW₁₋ₐSe₂, MoS_{b}Se_{2-b}, WS_{b}Se_{2-b}, or MoₐW₁₋ₐS_{b}Se_{2-b}, where 0<a≤1 and 0<b≤2, or combination thereof. Preferably, the transition metal dichalcogenide is selected from MoS₂, WS₂, MoSe₂, WSe₂. Most preferably from MoS₂ and WS₂. Such transition metal dichalcogenide is available commercially from ACS Material.

The transition metal dichalcogenide may be in the form of flakes having an average size of from 1 nm to 5000 nm, such as between 50 to 750 nm, 75 nm to 500 nm, 100 nm to 400 nm, for example 130 nm to 300 nm, 150 nm to 290 nm, or 160 nm to 280 nm, suitably 170 nm to 270 nm, 180 nm to 260 nm or preferably 190 nm to 250 nm. Suitably, the size distribution of the transition metal dichalcogenide flakes is such that at least 30 wt % of the transition metal dichalcogenide flakes have a diameter of between 1 nm to 5000 nm, such as between 50 to 750 nm, 75 nm to 500 nm, 100 nm to 400 nm, for example 130 nm to 300 nm, 150 nm to 290 nm, or 160 nm to 280 nm, suitably 170 nm to 270 nm, 180 nm to 260 nm or preferably 190 nm to 250 nm more preferably at least 40 wt %, 50 wt %, 60 wt %, 70 wt % and most preferably at least 80 wt % or at least 90 wt % or 95 wt % or 98 wt % or 99 wt %. The size of the transition metal dichalcogenide thereof and size distribution may be measured using transmission electron microscopy (TEM, JEM-2100F, JEOL Ltd. Japan).

For example, lateral sizes of the two-dimensional layers across a sample may be measured using transmission electron microscopy (TEM, JEM-2100F, JEOL Ltd. Japan), and the number (Nᵢ) of the same sized nanosheets (Mᵢ) measured. The average size may then be calculated by Equation 1:

Average size =Σᵢ₌₁^{∞}NᵢMᵢ/Σᵢ₌₁^{∞}Nᵢ

where Mᵢ is diameter of the nanosheets, and Nᵢ is the number of the size with diameter Mᵢ.

The transition metal dichalcogenide may be in the form of a monolayer or multi-layered particle or flake, preferably a monolayer. The transition metal dichalcogenide flakes may be formed of single, two or few layers of transition metal dichalcogenide, wherein few may be defined as between 3 and 100 layers. Suitably, the transition metal dichalcogenide flakes comprise between 1 to 100 layers, such as between 2 to 75 layers or 5 to 50 layers or 10 to 25 layers. Suitably, at least 30 wt % of the transition metal dichalcogenide comprise between 1 to 30 layers, such as between 5 to 30 layers or 5 to 10 layers, more preferably at least 40 wt %, 50 wt %, 60 wt %, 70 wt % and most preferably at least 80 wt % or at least 90 wt % or 95 wt % or 98 wt % or 99 wt %. The number of layers in the transition metal dichalcogenide flakes thereof may be measured using atomic force microscopy (AFM or transmission electron microscopy (TEM)) (TT-AFM, AFM workshop Co., CA, USA).

Suitably, the d-spacing between adjacent lattice planes in the transition metal dichalcogenide or mixture thereof is from 0.34 nm to 5000 nm, such as from 0.34 nm to 1000 nm, or from 0.4 to 500 nm, or from 0.4 to 250 nm, such as from 0.4 to 200 nm, or from 0.4 to 150 nm, or from 0.4 to 100 nm, or from 0.4 to 50 nm, or from 0.4 to 25 nm, or from 0.4 to 10 nm, or from 0.4 to 8 nm, such as from 0.4 to 7 nm, from 0.45 to 6 nm, 0.50 to 5 nm, or 0.55 to 4 nm, or 0.6 to 3 nm, for example 0.6 to 2.5 nm, 0.6 to 1 nm, 0.6 to 2 nm, or 0.6 to 1.5 nm.

The active layer may comprise materials, suitably two-dimensional materials, other than the transition metal dichalcogenide thereof. For example, other materials of the active layer may be selected from one or more of silicene, germanene, stanene, boron-nitride, suitably h-boron nitride, carbon nitride, metal-organic nanosheets, graphene, graphene oxide, reduced graphene oxide functionalised graphene oxide and polymer/graphene aerogel.

The active layer may comprise additives to tailor the properties of the active layer, such as other metals; and/or fibres, such as metal oxide nanostrands; and/or dopants, e.g. Au, Fe, Cu, Cu(OH)₂, Cd(OH)₂ and Zr(OH)₂. Such additives may be added to the membrane to control the interlayer distance and/or create nanochannels for high water flux rate. Any type of suitable fibres, such as continuous or chopped fibres, having diameter of 0.5-1000 nm may be incorporated within the membrane. Preferably, the fibres are removed before use, such as by mechanical removal or by dissolution, etc.

The addition of additives may be carried out by addition of the additives to the coating composition or depositing additives with desired functionality on the membrane surface.

The method of applying the active layer composition to the membrane device may comprise the step of applying a coating composition comprising the transition metal dichalcogenide onto the first support portion. The method may comprise contacting the coating composition onto the first support portion using gravity deposition, vacuum deposition, pressure deposition; printing such as inkjet printing, aerosol printing, 3D printing, offset lithography printing, gravure printing, flexographic printing techniques, pad printing; curtain coating, dip coating, spin coating, and other printing or coating techniques known to those skilled in the art.

Further details of the application methods are disclosed in published PCT patent application WO2019/122828, specifically, paragraphs [73] to [77] inclusive. The entire contents paragraphs [73] to [77] inclusive thereof are fully incorporated herein by reference.

The active layer coating composition may be a liquid composition comprising a liquid medium and the transition metal dichalcogenide. The coating compositions of the present invention may comprise solvent, non-solvent or solvent-less, and may be UV curable compositions, e-beam curable compositions etc. When formulated as a liquid composition for use in the invention, e.g. as a solution, dispersion or suspension, a suitable carrier liquid or solvent may be aqueous or organic, and other components will be chosen accordingly. For example, the liquid carrier may comprise water or an organic solvent such as ethanol, terpineol, dimethylformamide N-Methyl-2-pyrrolidone, isopropyl alcohol, mineral oil, ethylene glycol, or their mixtures, optionally with other materials to enhance performance and/or rheology of the composition including any one or more of binders, drying additives, antioxidants, reducing agents, lubricating agents, plasticisers, waxes, chelating agents, surfactants, pigments, defoamers and sensitisers.

Further details of the active layer composition are disclosed in published PCT patent

application WO2019/122828, specifically, paragraphs [46] to [61] inclusive. The entire contents paragraphs [46] to [61] inclusive thereof are fully incorporated herein by reference.

The graphene or derivative thereof may be selected from one or more of graphene oxide, reduced graphene oxide, hydrated graphene and amino-based graphene, alkylamine functionalised graphene oxide, ammonia functionalised graphene oxide, amine functionalised reduced graphene oxide, octadecylamine functionalised reduced graphene oxide, and/or polymer graphene aerogel. Preferably, the graphene or derivative thereof is graphene oxide. Graphene and its derivatives may be obtained commercially from Sigma-Aldrich.

Suitably, the graphene or derivative thereof, preferably graphene oxide, comprises hydroxyl, carboxylic and/or epoxide groups. The oxygen content of the graphene or derivative thereof, preferably graphene oxide, may be 0% to 60% oxygen atomic percentage, such as 0% to 50% or 0% to 45% oxygen atomic percentage. Suitably, the oxygen content is from 20% to 25% or from 25% to 45%. Advantageously, when the water content is between 25% to 45% a surfactant may not be present in the composition. Preferably, the oxygen content is from 30% to 40% oxygen atomic percentage. Such a range can provide improved stability despite the absence of other stabilising components. Suitably, when the graphene or derivative is reduced graphene oxide, the oxygen content is from 5% to 20% oxygen atomic percentage. Oxygen content can be characterised by X-ray photoelectron spectroscopy (XPS).

The graphene or derivative thereof, suitably graphene oxide, may be optionally substituted with further functional groups. The optional functional groups may be grafted functional groups, and preferably grafted via reaction with the existing hydroxyl, carboxylic and epoxide groups of the graphene or derivative thereof. Functionalisation includes covalent modification and non-covalent modification. Covalent modification method can be subcategorised to nucleophilic substitution reaction, electrophilic substitution reaction, condensation reaction, and addition reaction. Examples of optional functional groups are amine groups; aliphatic amine groups, such as long-chain (e.g. C₁₈ to C₅₀) aliphatic amine groups; porphyrin-functionalised secondary amine groups, and/or 3-amino-propyltriethoxysilane groups. The graphene or derivative thereof may comprise amino groups, suitably grafted amino groups, and preferably to graphene oxide. Such functionalisation can provide for the improved selective sieving of ferric acid.

The graphene or derivative thereof according to any aspect of the present invention may be in the form of flakes having a size of from 1 nm to 5000 nm, such as between 50 nm to 750 nm, 100 nm to 500 nm, 100 nm to 400 nm. The graphene or derivative thereof according to any aspect of the present invention may be in the form of flakes having a size of from 100 nm to 3500 nm, such as from 200 nm to 3000 nm, 300 nm to 2500 nm or 400 nm to 2000 nm, preferably from 500 nm to 1500 nm. The graphene or derivative thereof according to any aspect of the present invention may be in the form of flakes having a size of from 500 nm to 4000 nm, 500 nm to 3500 nm, 500 nm to 3000 nm, 750 nm to 3000 nm, 1000 nm to 3000 nm, such as 1250 nm to 2750 nm or preferably 1500 nm to 2500 nm. Suitably, the size distribution of the graphene flakes or derivative thereof is such that at least 30 wt % of the graphene flakes or derivative thereof have a diameter of between 1 nm to 5000 nm, such as between 1 nm to 750 nm, 100 nm to 500 nm, 100 nm to 400 nm; or between 100 nm to 3500 nm, such as from 200 nm to 3000 nm, 300 nm to 2500 nm or 400 nm to 2000 nm, preferably from 500 nm to 1500 nm; or between 500 nm to 4000 nm, 500 nm to 3500 nm, 500 nm to 3000 nm, 750 nm to 3000 nm, 1000 nm to 3000 nm, such as 1250 nm to 2750 nm or preferably 1500 nm to 2500 nm, more preferably at least 40 wt %, 50 wt %, 60 wt %, 70 wt % and most preferably at least 80 wt % or at least 90 wt % or 95 wt % or 98 wt % or 99 wt %. The size of the graphene flakes or derivative thereof and size distribution may be measured using transmission electron microscopy (TEM, JEM-2100F, JEOL Ltd. Japan).

The graphene or derivative thereof may be in the form of a monolayer or multi-layered particle, preferably a monolayer. The graphene flakes or derivative thereof may be formed of single, two or few layers of graphene or derivative thereof, wherein few may be defined as between 3 and 20 layers. Suitably, the graphene flakes or derivative thereof comprise between 1 to 15 layers, such as between 2 to 10 layers or 5 to 15 layers. Suitably, at least 30 wt % of the graphene flakes or derivative thereof comprise between 1 to 15 layers, such as between 1 to 10 layers or 5 to 15 layers, more preferably at least 40 wt %, 50 wt %, 60 wt %, 70 wt % and most preferably at least 80 wt % or at least 90 wt % or 95 wt % or 98 wt % or 99 wt %. The number of layers in the graphene flakes or derivative thereof may be measured using atomic force microscopy (AFM or transmission electron microscopy (TEM)) (TT-AFM, AFM workshop Co., CA, USA).

Suitably, the d-spacing between adjacent lattice planes in the graphene or derivative thereof is from 0.34 nm to 1000 nm, such as from 0.34 nm to 500 nm, or from 0.4 nm to 500 nm, or from 0.4 nm to 250 nm, such as from 0.4 nm to 200 nm, or from 0.4 nm to 150 nm, or from 0.4 nm to 100 nm, or from 0.4 nm to 50 nm, or from 0.4 nm to 25 nm, or from 0.4 nm to 10 nm, or from 0.4 nm to 5 nm, such as from 0.45 nm to 4 nm, from 0.5 nm to 3 nm, 0.55 nm to 2 nm, or 0.55 nm to 1.5 nm, or 0.6 nm to 1.2 nm, for example 0.6 nm to 1.1nm, 0.6 nm to 1 nm, 0.6 nm to 0.9 nm, or 0.6 nm to 0.8 nm.

The active layer may comprise materials, suitably two-dimensional materials, other than graphene or derivatives thereof. For example, other materials of the active layer may be selected from one or more of silicene, germanene, stanene, boron-nitride, suitably h-boron nitride, carbon nitride, metal-organic nanosheets, molybdenum disulfide, and tungsten disulfide, polymer/graphene aerogel.

The materials of the active layer may be produced using any of the suitable methods known to the skilled person. Two-dimensional silicene, germanene and stanene may be produced by surface assisted epitaxial growth under ultrahigh vacuum. Hexagonal two-dimensional h-boron nitride may be produced by several methods, such as mechanical cleavage, unzipping of boron nitride nanotubes, chemical functionalisation and sonication, solid-state reaction and solvent exfoliation and sonication. Among these methods, chemical method has been found to provide the highest yield. For example, h-boron nitride may be synthesised on single-crystal transition metal substrates using borazine as boron and nitride sources. Two-dimensional carbon nitride can be prepared via direct microwave heating of melamine and carbon fibre. Metal-organic frameworks (MOFs) can be produced by in-situ solvothermal synthesis method by mixing ingredients at high temperatures such as 100-140° C., followed by filtration. Two-dimensional molybdenum disulfide can be obtained by a few methods, such as mechanical exfoliation, liquid exfoliation and chemical exfoliation. Among these methods, chemical exfoliation has been found to provide high yield. One example is chemical exfoliation using lithium to chemically exfoliate molybdenum disulfide using centrifuge and filtration. Two-dimensional tungsten disulfide can be prepared by a deposition-thermal annealing method: vacuum deposition of tungsten and followed by thermal annealing by addition of sulphur. Polymer/graphene aerogel can be produced via coupling and subsequent freeze-drying using polyethylene glycol grafted graphene oxide.

Preferably, the active layer is substantially formed from two-dimensional material, suitably of graphene or a derivative thereof, more preferably graphene oxide or reduced graphene oxide, most preferably graphene oxide.

The method of applying the active layer composition to the membrane device may comprise the step of applying a coating composition comprising the graphene or derivative thereof onto the support layer. The method may comprise contacting the coating composition onto the support layer using gravity deposition, vacuum deposition, pressure deposition; printing such as inkjet printing, aerosol printing, 3D printing, offset lithography printing, gravure printing, flexographic printing techniques, pad printing; curtain coating, dip coating, spin coating, and other printing or coating techniques known to those skilled in the art.

Further details of the application methods are disclosed in published PCT patent application WO2019106344, specifically, paragraphs [47] to [49] and [61] to [69] inclusive. The entire contents paragraphs [47] to [49] and [61] to [69] inclusive thereof are fully incorporated herein by reference.

The active layer coating composition may be a liquid composition comprising a liquid medium and the graphene or derivative thereof. The coating compositions of the present invention may comprise solvent, non-solvent or solvent-less, and may be UV curable compositions, e-beam curable compositions etc. When formulated as a liquid composition for use in the invention, e.g. as a solution, dispersion or suspension, a suitable carrier liquid or solvent may be aqueous or organic, and other components will be chosen accordingly. For example, the liquid carrier may comprise water or an organic solvent such as ethanol, terpineol, dimethylformamide N-Methyl-2-pyrrolidone, isopropyl alcohol, mineral oil, ethylene glycol, or their mixtures, optionally with other materials to enhance performance and/or rheology of the composition including any one or more of binders, drying additives, antioxidants, reducing agents, lubricating agents, plasticisers, waxes, chelating agents, surfactants, pigments, defoamers and sensitisers.

Further details of the active layer composition are disclosed in published PCT patent

application WO2019106344, specifically, paragraphs [51] to [60] inclusive. The entire contents paragraphs [51] to [60] inclusive thereof are fully incorporated herein by reference.

The active layer may comprise a metal-organic framework.

The metal-organic framework materials of any aspect of the present invention may be one-dimensional, two-dimensional or three-dimensional. Preferably, the MOF is porous. The MOF may comprise a network of secondary building units (SBUs), or metal ion core/metal subunit cluster core nodes, and organic linkers (or ligands) connecting the SBUS or nodes.

The MOF may be in continuous phase in the active layer or may be in the form of flakes and/or particles. A MOF synthesised in the presence of first support portion may be in the form of continuous phase. A MOF formed prior to contact with the first support portion may be in the form of flakes and/or particles.

The SBUs or nodes, being sub units of the MOF, may comprise metal selected from one or more transition metal cations, such as one or more of Cr(III), Fe(II), Fe(III), Al(III), Co(II), Ru(III), Os(III), Hf(IV), Ni, Mn, V, Sc, Y(III), Cu(II), Cu(I), Zn(II), Zr(IV), Cd, Pb, Ba, Ag (I), Au, AuPd, Ni/Co, lanthanides, actinides, such as Lu, Tb(III), Dy(III), Ho(III), Er(III), Yb(III). Preferably Cr(III), Fe(II), Fe(III), Al(III), Co(II), Ru(III), Os(III), Hf(IV), Ni, Mn, V, Sc, Y(III), Cu(II), Cu(I), Zn(II), Zr(IV), Cd, Pb, Ba, Ag (I), Ni/Co, lanthanides, actinides, such as Lu, Tb(III), Dy(III), Ho(III), Er(III), Yb(III). More preferably Cr(III), Fe(II), Fe(III), Al(III), Co(II), Hf(IV), Ni, Mn, V, Sc, Y(III), Cu(II), Cu(I), Zn(II), Zr(IV), Cd, Pb, Ag (I), Ni/Co, lanthanides, actinides, such as Lu, Tb(III), Dy(III), Ho(III), Er(III), Yb(III), more preferably Cr(III), Fe(II), Fe(III), Al(III), Co(II), Hf(IV), Ni, Mn, V, Y(III), Cu(II), Cu(I), Zn(II), Zr(IV), Cd, Ag (I), Ni/Co, lanthanides, actinides, such as Lu, Tb(III), Dy(III), Ho(III), Er(III), Yb(III). The secondary building unit (SBU) may comprise: three, four, five, six, eight, nine, ten, eleven, twelve, fifteen or sixteen points of extension.

The SBU or node may be a transition-metal carboxylate cluster. The SBUs or nodes may be one or more selected from the group consisting of Zn4O(COO)6, Cu2(COO)4, Cr3O(H2O)3(COO)6, and Zr6O4(OH)10(H2O)6(COO)6), Mg2(OH2)2(COO), RE4(μ3-O)2(COO)8, RE4(μ3-O)2, wherein RE is Y(III), Tb(III), Dy(III), Ho(III), Er(III), and/or Yb(III)). The structures of SBUs can be identified by X-Ray diffraction using methods well known to the skilled person.

Organic linkers suitable for use in the present invention include those operable to be used to form MOFs for water treatment, molecule separation, and biofiltration related applications. Such linkers may form strong bonds to metal cores, provide large pore sizes, provide high porosity, provide selective absorption and/or capacity.

The organic linkers of the MOF may be formed from a wide range of organic molecules, such as one or more carboxylate linkers; N-heterocyclic linkers; phosphonate linkers; sulphonate linkers, metallo linkers, such a carboxylate-metallo linkers; and mixtures and derivatives thereof.

The organic linkers may comprise one or more of ditopic, tritopic, tetratopic, hexatopic, octatopic linkers. The organic linkers may comprise desymmetrised linkers.

The organic linkers may comprise one or more ditopic carboxylate linkers, such as one or more of the group consisting of 4,4′-biphenyldicarboxylate (bpdc), 2,2′-dicyano-4,4′-biphenyldicarboxylate (CNBPDC), 9,10-anthracenedicarboxylate (adc), 4,4′-azobenzenedicarboxylate (abdc), 1,3-bis(3,5-dicarboxylphenylethynyl)benzene (bdpb), 2,2′-bipyridyl-5,5′-dicarboxylate (bpydc), 2,2′-dihydroxy-1,1′-binaphthalene-5,5′-dicarboxylate(5,5′-bda), 2-bromobenzene-1,4-dicarboxylate (brbdc), 1,4-benzenedicarboxylates (BDC), BDC-Br, BDC-NH2, BDC-OC3H7, BDC-OC5H11, BDC-cycC2H4, BDC-ben, 2-bromo-1,4-benzenedicarboxylate (o-Br-bdc), BDC-F, BDC-CI, BDC-Br, BDC-I, BDC-F₄, BDC-Cl₄, BDC-Br₄, BDC-I₄, BDC-(CH3)4, 2,5-dihydroxy-1,4-benzenedicarboxylate (DHBDC), thieno[3,2-b]thiophene-2,5-dicarboxylic acid (TTDC), thiophene-2,5-dicarboxylate (tdc), di-thieno-[3,2-b;2′,3′-d]-thiophene-2,6-dicarboxylate (DTTDC), naphthalenedicarboxylate (NDC), 4,4′-benzophenone dicarboxylate (BPNDC), 4,4′-biphenyldicarboxylate (BPDC), 2,2′-dicyano-4,4′-biphenyldicarboxylate (CNBPDC), pyrene-2,7-dicarboxylate (PDC), p,p′-terphenyldicarboxylic acid (TPDC), amino-TPDC, pyridine 2,6-dicarboxylic acid HPDC, Thiol functionalised DMBD, azide-functionalized 2,3,5,6-tetramethylbenzene-1,4-dicarboxylate (TBDC), tetraanionic 2,5-dioxido-1,4-benzene-dicarboxylate (BOBDC/DHBDC/DOT).

The organic linkers may comprise one or more tritopic carboxylate linkers, such as one or more of the group consisting of 1,3,5- benzenetricarboxylate (btc), biphenyl-3,4′,5-tricarboxylate (bhtc), 4,4′,4″-benzene-1,3,5-triyl-benzoate (btb), 4,4′,4″-(triazine-2,4,6-triyltris(benzene-4,1-diyl))tribenzoate (tapb), 4,4′,4″-benzene-1,3,5-triyl-benzoate, 4,4′,4″(benzene-1,3,5-triyltris(ethyne-2,1-diyl))tribenzoate (bte), 4,4′,4″-(benzene-1,3,5-triyl-tris(benzene-4,1-diyl))tribenzoate (bbc).

The organic linkers may comprise one or more tetratopic carboxylate linkers, such as one or more of the group consisting of 1,1′-azobenzene-3,3′,5,5′-tetracarboxylate (abtc), azoxybenzene-3,3′,5,5′-tetracarboxylate (aobtc), 4,4′-bipyridine-2,6,2′,6′-tetracarboxylate (bpytc), such as (4′,4″,4′″,4″″-methanetetrayltetrabiphenyl4-carboxylate, mtbc), 4,4′,4″,4′″-Methanetetrayltetrabenzoic acid (MTB), benzene-substituted 4,4′,4″,4′″-Methanetetrayltetrabenzoic acid MTTB, 4,4′,4″-tricarboxyltriphenylamine (TCA), 4,4′,4″,4′″-tetrakiscarboxyphenylsilane (TCPS), 2-thiophenecarboxylic acid (HTPCS), methanetetra(4-benzoate) (MTBA), 1,3,5,7-adamantane tetracarboxylate (act), N,N,N′,N′-tetrakis(4-carboxyphenyl)-1,4-phenylenediamine (TCPPDA), 5,5′-(1,2-ethynediyl)bis(1,3-benzenedicarboxylate) (ebdc), 3,3′,5,5′-biphenyltetracarboxylate (bptc), 3,3′,5,5′-erphenyltetracarboxylate, 3,3′,5,5′-quaterphenyltetracarboxylate, 3,3′,5,5′-pentaphenyltetracarboxylate, 5,5′-(9,10-anthracenediyl)diisophthalate (adip), 3,3′,5,5′-tetra-(phenyl-4-carboxylate), 9,9′-([1,1′-biphenyl]-4,4′-diyl)bis(9H-carbazole-3,6-dicarboxylate) (bbcdc).

The organic linkers may comprise one or more hexatopic carboxylate linkers, such as one or more of the group consisting of 5,5′,5″-[1,3,5-benzenetriyltris(carbonylimino)]tris-1,3-benzenedicarboxylate, 5,5′,5″-(((benzene-1,3,5-triyl-tris(ethyne-2,1-diyl))-tris(benzene-4,1-diyl))tris(ethyne-2,1-diyl))triisophthalate (ttei), 1,3,5-tris[((1,3-carboxylic acid-5-(4(ethynyl)phenyl))ethynyl)phenyl]-benzene, 3,3′,3″,5,5′,5″-benzene-1,3,5-triyl-hexabenzoate (bhb), 4,4′,4″-tris(N,N-bis(4-carboxylphenyl)-amino)triphenylamine (H6tta), 1,3,5-tris[(1,3-di(4′-carboxylic acid-phenyl)-phenyl)-5-ethynyl]benzene] (H6L1), tris-(4-(5′-ethynyl-1,1′:3′,1″-terphenyl-4,4″-dicarboxylic acid)-phenyl)-amine] (H6L2), 1,1′:3′,1″-terphenyl-4,4″-dicarboxylate.

The organic linkers may comprise one or more metallo linkers, such as one or more of the group consisting of [FeFe]-1,4-dicarboxylbenzene-2,3-dithiolate (dcbdt), Cu(I)-1,10-phenanthroline-based linker, 5,10,15,20-Tetrakis(4-carboxyphenyl)porphyrin metalloporphrin linker (tcpp), Au(I)-4,4′,4″,4′″-(1,2-phenylenebis(phosphanetriyl))-tetrabenzoate (pbptbc), 4,7-bis(4-carboxylphenyl)-1,3-dimethyl-benzimidazolium-tetrafluoroborate, [(R,R)-(2)-1,2-cyclohexanediamino-N,N′-bis(3-tert-butyl-5-(4-pyridyl)salicylic-dene)-Mn(III)Cl].

The organic linkers may comprise one or more octatopic carboxylate linkers, such as one or more of the group consisting of 5,5′,5″,5′″-silanetetrayltetraisophthalate (L6), 1,1′-binaphthyl-derived octacarboxylate linkers, 2,2′-diethoxy-1,1′binapthyl-4,4′,6,6′-tetracarboxylic acid (L12) and elongated L12 (L13, wherein a —C═C— moiety is present in each arm of L12).

The organic linkers may comprise one or more N-heterocyclic linkers such as one or more of the group consisting of 2,5-bis-(2-hydroxyethoxy)-1,4-bis(4-pyridyl)benzene, 4,4′-dipyridylacetylene (dpa), pyrazine, imidazolate or derivative thereof, such as 1,4-bis(imidazolyl)-benzene and 1,5-bis(imidazol-1-ylmethyl)naphthalene, imidazole (Him), 2-methylimidazole, 2-ethyl imidazole, 2-nitro imidazole, 4-isocyanoimidazole, 4,5-dichloroimidazole, imidazole-2-carbaldehyde, imidazo[4,5-b]pyridine, benzo[d]imidazole, 6-chloro-benzo[d]imidazole, 5,6-dimethyl-benzo[d]imidazole, 6-methyl-benzo[d]imidazole, 6-bromo-benzo[d]imidazole, 6-nitro-benzo[d]imidazole, imidazo[4,5-c]pyridine, purine pyrazole (Hpz), 1,2,4-triazole (Htz), 1,2,3-triazole (Hta), and tetrazole (Httz), 5-chlorobenzimidazolate (cblm), 1,3,5-tris(1H-pyrazol-4-yl)benzene, 2,2′-bipyridine (BIPY), 2-phenylpyridine-5,4-dibenzoate (PPY-DC), 2,2 bipyridine-5,5-dibenzoate (BPY-DC).

The organic linkers may comprise one or more phosphonate linkers, such as one or more of the group consisting of phosphonate-oxalate, alkylphosphonic acids wherein alkyl is C1 to C10, such as methylphosphonic acid, (H2O3P(CH2)nPO3H2) (Cn)) wherein n is 1 to 10, methylenebisphosphonate, alkylbis(phosphonic acid); methylenebis(phosphonic acid), N,N′-piperazinebis(methylenephosphonic acid), para-sulfonylphenylphosphonic acid, N,N′-4,4′-bipiperidinebis(methylenephosphonic acid), N,N′-piperazinebis(methylenephosphonic acid), N,N′-2- methylpiperazinebis(methylenephosphonic acid), arylphosphonate, 4-carboxyphenylphosphonic acid (4-cppH3), 1,3,5-benzenetris(phosphonic acid), tris-1,3,5-(4-phosphonophenyl)-benzene (H6L), biphenylbisphosphonate, bipyridylphosphonates, methylphosphonates, or functionalised phosphate linkers, such as 2′-bipyridyl-5,5′-bis(phosphonic acid).

The organic linkers may comprise one or more sulphonates, such as one or more of the group consisting of 4-biphenylsulfonate, 2-naphthalenesulfonate, 1-naphthalenesulfonate, 1-pyrenesulfonate, 1,5- naphthalenedisulfonate, 2,6-naphthalenedisulfonate, 1-naphthalene sulfonate, p-toluenesulfonate and 1,3,6,8- pyrenetetrasulfonate; 1,3,5-tris(sulfonomethyl)benzene; α,α′,α′″,α″″-durenetetrasulfonate, 1,3,5,7-tetra(4-sulfonophenyl)adamantane, 1,3,5,7-tetra(4-sulfonophenyl)adamantane, 1,3,5,7-tetra(4-sulfonophenyl)adamantane; (4,4′-bis(sulfoethynyl)biphenyl; 4,4′-biphenyldisulfonate, p-sulfonatocalix[4]arene, p-sulfonatocalix[5]arene, p-sulfonatocalix[6]arene, p-sulfonatocalix[8]arene.

The organic linkers may comprise an elongated organic linker, such an elongated linker may have a weight average molecular weight (Mw) of up to 1500 Da, such as up to 1300 Da, up to 1300 Da, up to 1100 Da, up to 1000 Da, up to 900 Da, up to 850 Da, up to 800 Da, or up to 750 Da. The elongated linker may be a tritopiclinker, such as one or more selected from the group consisting of 4,4′,4″-s-triazine-1,3,5-triyltri-p-aminobenzoate (tatab), 4,4′,4″-(1,3,4,6,7,9,9-heptaazaphenalene-2,5,8-triyl)tribenzoate (htb), 4,4′,4″-s-triazine-2,4,6-triyl-tribenzoate (tatb), 4,4′,4″-(benzene-1,3,5-triyl-tris(benzene-4,1-diyl))tribenzoate (bbc), bipyridine (bpy); or an elongated BPY- or PPY-containing dicarboxylate linker, such as di-benzoate-substituted 2,2′-bipyridine (bpy-dc), di-benzoate-substituted 2-phenylpyridine (ppy-dc); or a ditopic carboxylate linker containing three phenylene groups and two acetylene groups; or 3,3′-(naphthalene-2,7-diyl)dibenzoate, 5,5′-(naphthalene-2,7-diyl)-diisophthalate, 3,3′-(naphthalene-2,7-diyl)-dibenzoate, 4,4′-azanediyldibenzoate, 4,4′-bipyridine (L4), 4,4′-azobis(pyridine) (L5).

The organic linkers may comprise a mixture of different organic linkers, for example a mixture of ditopic and ditopic linkers, such as 9,10-bis(triisopropylsilyloxy)phenanthrene-2,7-dicarboxylate (tpdc) and 3,3′,5,5′-tetramethyl-4,4′-biphenyldicarboxylate (Me4bpdc); or a ditopic linker plus tritopic linker, such as carboxylate-pyridine linkers, for example, dipyridylfunctionalized chiral Ti(salan) and 4,4′-biphenyldicarboxylate (bpdc).

The linker may be selected from one or more selected from the group consisting of diacetylene-1,4-bis-(4-benzote), 2-methylpiperazine, piperazine (pip), 4,4′,4-methanetriyltris(2,3,5,6-tetrachlorobenzoate) (ptmtc), F-H2PDA, CDDB, 5-NH2-mBDC, dhtpa, pDBI, H3ImDC, hexaflurosilicate, fumaric acid, muconic acid, olsalazine, 5,5′,5″-(2-aminobenzene-1,3,5-triyl)tris(ethyne-2,1-diyl)triisophthalic acid (abtt), acetylacetonate (acac), 5,5′-(9,10-anthracenediyl)diisophthalate (adip), 3-aminopropyltrialkoxysilane (aps), 1,3-azulenedicarboxylate (azd), N,N′-bis(3,5-dicarboxyphenyl)pyromellitic diimide (bdcppi), 5,5′-(buta-1,3-diyne-1,4-diyl)diisophthalate (bddc/bdi), 1,4-benzenedi(4′-pyrazolyl) (bpd), 1,4-benzeneditetrazolate (bdt), 1,2-bis(4-pyridyl)ethane (bpe), 3,6-di(4-pyridyl)-1,2,4,5-tetrazine (bpta, dpt, or diPyTz), 4,4′,4″,4′″-benzene-1,2,4,5-tetrayltetrabenzoate (btatb, same as TCPB), bis(1H-1,2,3-triazolo[4,5-b],-[4′,5′-i])dibenzo[1,4]-dioxin (btdd), 5,5′,5″-benzene-1,3,5-triyltris(1-ethynyl-2-isophthalate) (btei), 1,3,5-benzenetristetrazolate (btt), 5,5′,5″-(benzene-1,3,5-triyl-tris(biphenyl-4,4′-diyl))triisophthalate (btti), 1,12-dicarboxyl-1,12-dicabra-closo-dodecarborane (cdc), 4-(α,α,α-trifluoromethyl)pyridine (CF3Py), 4-carboxycinnamate (cnc), 1,4,8,11-tetraazacyclotetradecane (cyclam), 1,4-diazabicyclo[2.2.2]octane (dabco), 1,2-dihydrocyclobutabenzene-3,6-dicarboxylate (dbdc), 6,6′-dichloro-2,2′-dibenzyloxy-1,1′-binaphthyl-4,4′-dibenzoate (dcbBn), 3,5-dicyano-4-(4-carboxyphenyl)-2,20:6,4″-terpyridine (dccptp), 6,6′-dichloro-2,2′-diethoxy-1,10-binaphthyl-4,4′-dibenzoate (dcdEt), diethylformamide (def), diethylenetriamine (deta), 2,5-dihydroxyterephthalate (dhtp), N,N′-di-(4-pyridyl)-1,4,5,8-naphthalenetetracarboxydiimide (diPyNl), 1,4-diazabicyclo[2.2.2]octane (dabco), 2,5-dioxido-1,4-benzenedicarboxylate (dobdc) meso-1,2-bis(4-pyridyl)-1,2-ethanediol (dpg), 5,5,40 -(1,2-ethynediyl)bis(1,3-benzenedicarboxylate) (ebdc), ethylene diamine (ed), 4-ethylpyridine (EtPy), 4,4′-(idene hexafluoroisopropylidene)-dibenzoate (hfipbb), fumarate (fma), 5-fluoropyrimidin-2-olate (F-pymo), 2-fluoro-4-(1H-tetrazole-5-yl)benzoate (2F-4-tba), 4,5,9,10-tetrahydropyrene-2,7-dicarboxylate (hpdc), 1,3,4,6,7,8-hexahydro-2H-pyrimido[1,2-a]pyrimidine (hpp), 4,5-imidazoledicarboxylate (ImDC), isonicotinate (in), 5,5′-methylene diisophthalate (mdip), 1-methylimidazole (MeIM), 4-methylpyridine (MePy), mercaptonicotinate (mna), methanetetrabenzoate (mtb), 4,4′,4″-nitrilotrisbenzoate (ntb), 4′,4″,4′″-nitrilotribiphenyl-3,5-dicarboxylate (ntbd), naphthalene-1,4,5,8-tetracarboxylate (ntc), 5,5′,5″-(4,4′,4″-nitrilotris(benzene-4,1-diyl)tris(ethyne-2,1-diyl))triisophthalate (ntei), oxidiacetate (oxdc), 4-(4-pyridyl) benzoate (pba), pyridine-3,5-bis(phenyl-4-carboxylate) (pbpc), p-phenylenediacylate (pda), pyridinedicarboxylate (pdc), 5-(pyridin-3-ylethynyl)isophthalate (peip), 4,6-pyrimidinedicarboxylate (PmDC), 5-[(pyridin-3-ylmethyl)amino]isophthalate (pmip), diphenylmethane-3,3′,5,5′-tetrakis(3,5-bisbenzoate) (pmtb), piperazine (ppz), 5,5′-((5′-(4-((3,5-dicarboxyphenyl)ethynyl)phenyl)-[1,1′:3′,1″-terphenyl]-4,4″-diyl)-bis(ethyne-2,1-diyl))diisophthalate (ptei), pyrene-2,7-dicarboxylate (pydc), 5-methyl-4-oxo-1,4-dihydropyridine-3-carbaldehyde (pyen), 2-pyrimidinecarboxylate (pymc), pyrimidinolate (pymo), pyrene-2,7-dicarboxylate (pyrdc), quaterphenyl-3,3′″,5,5′″-tetracarboxylate (qptc), trans-stilbene-3,3′,5,5′-tetracarboxylate (sbtc), 5-sulfoisophthalate (sip), 4,4′,4″-s-triazine-2,4,6-triyltribenzoate (tatb), 4-(1H-tetrazole-5-yl)benzoate (4-tba), 5-tert-butyl-1,3-benzenedicarboxylate (tbbdc), 5-t-butyl isophthalate (tbip), 5,5′,5″-(2,4,6-trimethylbenzene-1,3,5-triyl)tris(ethyne-2,1-diyl)triisophthalate (tbtt), tris(4-carboxybiphenyl)amine (tcbpa), tetrakis[4-(carboxyphenyl)-oxamethyl]methane (tcm), 1,2,4,5-tetrakis(4-carboxyphenyl)-benzene (tcpb), N,N,N′,N′-tetrakis(4-carboxyphenyl)biphenyl-4,4′-diamine (tcpbda), tetra-fluoroterephthalate (tftpa), 3,3′,5,5′-tetra(4-carboxyphenyl)-2,2′-diethoxylbiphenyl (tcpdep), N,N,N′,N′-tetrakis(4-carboxyphenyl)-1,4-phenylenediamine (tcppda), thieno[3,2-b]thiophene-2,5-dicarboxylate (T2DC), triethylenediamine (ted), tetrafluoroterephthalate (tfbdc), tetramethylterephthalate (tmbdc), 1,3,5-tri-p-(tetrazol-5-yl)phenylbenzene (TPB-3tz), 2,4,6-tri-p-(tetrazol-5-yl)phenyl-s-triazine (TPT-3tz), 2,4,6-tri(3-pyridyl)-1,3,5-triazine (3-tpt), 2,4,6-tri(4-pyridyl)-1,3,5-triazine (4-tpt), terphenyl-3,3″,5,5″-tetracarboxylate (tptc), 5,10,15,20,-tetra-4-pyridyl-21H,23H-porphyrine (TPyP), 1,2,4-triazolate (trz), 5,5′,5″-(((benzene-1,3,5-triyltris(ethyne-2,1-diyl))tris(benzene-4,1-diyl))tris-(ethyne-2,1-diyl))triisophthalate (ttei), tetrakis(4-tetrazolylphenyl)methane (ttpm), 3,5-bis(trifluoromethyl)-1,2,4-triazolate (Tz), tetrazolate-5-carboxylate (Tzc), TZI 5-tetrazolylisophthalate, ViPy 4-vinylpyridine, 2,3-Dimethyl-1,3-butadiene (DMBD).

The organic linkers may comprise one or more from the group consisting of 9,10-anthracenedicarboxylic acid, biphenyl-3,3′,5,5′-tetracarboxylic acid, biphenyl-3,4′,5-tricarboxylic acid, 5-bromoisophthalic acid, 5-cyano-1,3-benzenedicarboxylic acid, 2,2′-diamino-4,4′-stilbenedicarboxylic acid, 2,5-diaminoterephthalic acid, 2,2′-dinitro-4,4′-stilbenedicarboxylic acid, 5-ethynyl-1,3-benzenedicarboxylic acid, 2-hydroxyterephthalic acid, 3,3′,5,5′-azobenzene tetracarboxylic acid, [1,1′-biphenyl]-4,4′-dicarboxylic acid, 2,5-dihydroxyterephthalic acid, 2,6-naphthalenedicarboxylic acid, 1,4-phenylenediacetic acid, 1,1,2,2-tetra(4-carboxylphenyl)ethylene, 1,3,5-tricarboxybenzene, 1,3,5-tris(4-carboxyphenyl)benzene, 1,4-di(4′-pyrazolyl)benzene, 1,4,7,10-teraazaacyclododecane-N,N′,N″,N′″-tetraacetic acid, 2,4,6-(tri-4-pyridinyl)-1,3,5-triazine, tris(isobutylaminoethyl)amine, 2-(diphenylphosphino)terephthalic acid.

MOFs suitable for use in the present invention include those operable to be used water treatment, molecule separation, biofiltration and related applications. Suitable MOFs preferably have water and chemical stability. The MOFs may have water insoluble linkers, and/or solvent-stable linkers, and/or strong covalent bonds between SBU and linkers, and/or multi-covalent bonds between SBU and linkers. Water and chemical stability may mean that the MOFs do not fully disassemble to linkers and SBUs in the presence of water and/or chemicals. Suitable MOFs may have covalent bond links between the linkers and the SBUs or nodes, and/or coordinate bonding between the linkers and the SBUs or nodes.

Suitable MOFs may have high surface area and/or large pore sizes. The MOF may have surface area of at least 10 m²/g, such as 100 to 9,000 m²/g, preferably 100 to 8,000 m²/g or 500 to 8,000 m²/g. The surface area can be measured using the known Brunauer, Emmett and Teller (BET) technique. The MOFs according to any aspect of the present invention, suitably in the form of porous flakes or particles, may have an average pore size of from 0.1 nm to 1000 nm, 0.1 to 950 nm, 0.2 to 900 nm, 0.2 to 850 nm, preferably 0.2 to 800 nm, 0.3 to 700 nm, preferably 0.4 to 650, 0.4 to 550 nm, 0.5 to 500 nm, 0.5 to 450 nm, 0.2 nm to 100 nm, such as between 0.2 nm to 90 nm, 0.3 nm to 75 nm, 0.4 nm to 50 nm, for example 0.4 nm to 40 nm, 0.4 nm to 30 nm, or 0.4 nm to 20 nm, suitably 0.4 nm to 15 nm, 0.4 nm to 10 nm.

The MOF may comprise a pillared-layer MOF. Suitably, in a pillared-layer MOF 2D sheets function as scaffolds for organic linkers, such as dipyridyl linkers. Advantageously, this can allow for diverse functionalities to be incorporated into the MOF, such as —SO₃²_groups. The use of SO₃²_groups can induce a polarized environment and strong acid-base interaction with acidic guests like CO2. Furthermore, different pillar linker groups, such as —N═N— compared to —CH═CH—, provide different selectivity to H₂O and methanol.

The MOF may comprise a functional group. The MOF may in particular be adapted for water treatment, molecule separation, and biofiltration related applications by the MOF comprising a functional group, suitably on one or more of the organic linkers. Said functional groups may provide selectivity and/or increase pore sizes for high adsorption capacity or high flux rate. The functional group may be selected from one or more of the group consisting of —NH₂, —Br, —Cl, —I, —(CH₂)ₙ—CH₃ wherein n is 1 to 10, such as CH₃CH₂CH₂O—, CH₃CH₂CH₂CH₂O—, ben—C₄H₄, methyl, —COON, —OH. For example, the MOF may be an IRMOF, such as IRMOF-1, IRMOF-2, IRMOF-3, IRMOF-4, IRMOF-5, IRMOF-6, IRMOF-7, IRMOF-8, IRMOF-9, IRMOF-10, IRMOF-16, IRMOF-11, IRMOF-12, IRMOF-13, IRMOF-14, IRMOF-15; and/or a CAU, such as CAU-10-OH, CAU-10-NH₂, CAU-10-H, CAU-10-CH₃; and/or MIL-125-NH2; and/or UiO-66(Zr)-(CH3)2.

The MOF may be selected from one or more of Zr-DUT-51, Hf-DUT-51, PCN-777, NU-1105, DUT-52, DUT-53, DUT-84, DUT-67, DUT-68, DUT-69, DUT-6, such as MIL-125 (Fe, Cr, Al, V), MIL-53 (Fe, Cr, Al, V), MIL-47(Fe, Cr, Al, V), UAM-150, UAM-151, UAM-152, Zr(O3PC12H8PO3), Zr Bipyridylphosphonates, Zr Methylphosphonates, Sn(IV) Bipyridylphosphonates, Sn(IV) Methylphosphonates, [Ag(4-biphenylsulfonate)]^{∞}, [Ag(2-naphthalenesulfonate)]²⁸, [Ag(H2O)0.5(1-naphthalenesulfonate)]^{∞}, [Ag(1-naphthalenesulfonate)]^{∞} and [Ag(1-pyrenesulfonate)]^{∞}, UO₂(O₃PC₆H₅)₃0.7H₂O, (UO₂)₃(HOPC₆H₅)₂—(O₃PC₆H₅)₂3H₂O, SAT-16, SAT-12 (Mn²⁺, Fe²⁺, Co²⁺, Ni²⁺), MIL-91 (Al³⁺, Fe³⁺, In³⁺, V³⁺), STA-13 (Y³⁺, Sc³⁺, Yb³⁺, Dy³⁺), VSN-3 (with —CH₂— units ranging from 1 to 10) , VSB-4 (with —CH₂— units ranging from 1 to 10), ZIF-95, ZIF-100, M₃(btp)₂ (M=Ni,Cu, Zn, and Co; H3btp=1,3,5-tris(1H-pyrazol-4-yl)benzene), IRMOF-76, IRMOF-77, PCM-18, MOF-1040, MOF-253_0.08PdCl₂, MOF-253_0.83PdCl₂, MOF-253_0.97Cu(BF₄)₂, NOTT-115, UMCM-150, UMCM-154, MOF-5, FJI-1, MOF-100, MOF-177, MOF-210, UMCM-1, UMCM-2, UMCM-3, UMCM-4, UMCM-8, UMCM-9, MTV-MOF-5, L6-L11; PCN-80, UNLPF-1, NOTT-140, UTSA-34a, UTSA-34b, MODF-1, SDU-1, NPG-5, UTSA-20, NU-100, NU-110E, PCN-61, PCN-66, PCN-69, PCN-610, DUT-49, PCN-88, NOTT-300, NOTT-202, NOTT-104, PCN-46, PCN-14, NOTT-100, NOTT-101, NOTT-103, NOTT-109, NOTT-111, ZSA-1, ZSA-2, NOTT-12, NOTT-16, POMF-Cu ([Cu₂₄L₈(H₂O)₂₄], MIL-59, PCN-12, PCN-12′, DUT-75, DUT-76, PCN-16, PCN-16′, PCN-511, IMP-11, PCN-512, IMP-9, MOF-11, MOF-36, Hf-PCN-523, PCN-521, MOF-177, MOF-180, MOF-200, SNU-150, MOF-14, MOF-143, MOF-388, MOF-399, UiO-88, MOF-1001, IRMOF-62, MOF-101, IRMOF-74, CAU-10-OH, CAU-10-NH₂, CAU-10-H, CAU-10-CH₃, CAU-10, CALF-25, Zn-DMOF, Co-DMOF, DUT-4, SAPO-34, SBA-15, HZSM-5, MCM-41, KIT-1, MCM-48, Zn-MOF-74, Ni-MOF-74, Mg-MOF-74, PCN-228, PCN-229, PCN-230, =MOF-808, MIL-160, MIL-163, FJI-H6, [Zr6O4(OH)4(btba)3](DMF)x(H₂O)y wherein x is 0 to <20 and y is 0 to <20, FJI-H7, lanthanide element-based [La(pyzdc)1.5(H2O)2]2H2O, [Dy(Cmdcp)(H2O)3](NO3)2H2O)n, [Eu(HL)(H2O)2]n2H2O, Tb-DSOA, [Tb(L)(OH)]x(slov), ([Tb(L1)1.5(H2O)]3H2O, In-based JLU-Liu18, Al-based MIL-121, MAF-6, MAF-7, MAF-49, MAF-X8, [Zn12(trz)20][SiW12O40]11H2O, Zn2TCS(4′4-bipy), Zn-pbdc-11a(bpe)/-12a(bpe)/-12a(bpy), Zn(IM)1.5(abIM)0.5, ([Zn(C10H2O8)0.5(C10S2N2H8)]5H2O))n, Co/Zn-BTTBBPY, PCN-601, Mg-CU K-1, [Cd2(TBA)2(bipy)(DMA)2], Cu6(trz)10(H2O)4[H2SiW12O40}8H2O, [Ni(BPEB)], [Eu3(bpydb)3(HCOO)(u3-OH)2(DMF)](DMF)3(H2O)2, MAF-X25, MAF-X27, MAF-X25ox, MAF-27ox, PCN-101, NH2-MIL-125(Ti), Cu(I)-MOF, AEMOF-1, PCN-222, Cd-EDDA, [Cd2L2]NMPMEOH, Eu/UiO-66-(COOH)2, Eu/CPM-17-Zn, Eu/MIL-53-COOH(Al), [Ln(HL)(H2O)2]n2H2O, Eu3+@MIL-124, ([Tb(L1)1.5(H2O)]3H2O)n, [Tb(I)(OH)]x(solv), bio-MOF-1, BFMOF-1, NENU-500, Co-ZIF-9, Al2(OH)2TCPP-Co, Al-MIL-101-NH-Gly-Pro, UiO-66-CAT, Pt/UiO-66, HPW@MIL-101, POM-ionic-liquid-functionalized MIL-100, sulphated MIL-53, MIL-101(Cr)-NO2, NENU-1/12-tungstosilicic acid, Na-HPAA, PCMOF-10, Ca-PiPhtA, (NH4)2(adp)[Zn2(ox)3]3H2O, ([Zn(C10H2O8)0.5(C10S2N2H8)]5H2O])n, ([(Me2NH2]3(SO4))2[Zn2(ox)3])n, UiO-66-(SO3H)2, Tb-DSOA, [La3L4(H2O)6]ClxH2O, CALF-25, (Cu212)[Cu2PDC2-(H2O)2]2[Cu(MeCN)4]IDMF, (Cu414)[Cu2PDC2-(H2O)2]4DMF, (Cu212)[Cu3PDC3-(H2O)2]2MeCN)2DMF, ZIF-1, ZIF-3, ZIF-4, ZIF-6, ZIF-10, ZIF-11, ZIF-12, ZIF-14, ZIF-20, ZIF-22, ZIF-9-67, ZIF-60, ZIF-67, ZIF-68, ZIF-69, ZIF-74, ZIF-76, ZIF-77, ZIF-78, ZIF-79, ZIF-80, ZIF-81, ZIF-82, ZIF-90, ZIF-95, ZIF-100, UiO-68., MOF-801, MOF-841, [Co4L3(u3-OH)(H2O)3](SO4)0.5, MOF-802, Cu-BTTri, PCN-426, MOF-545, Zn(1,3-BDP), [(CH₃)2NH2]2[Eu6(u3-OH)8(1,4-NCD)6(H2O)6], NiDOBDC, Al(OH)(2,6-ndc) (ndc is naphthalendicarboxylate), MOF-525, MOF-535, Co-MOF-74, [Zn4(u4-O)-(u4-4-carboxy-3,5-dimethyl-4-carboxy-pyrazolato)3], PCP-33, NU-100, IRMOF-74-III-CH2NH2, Zn-pbdc-12a(bpe), mmen-Mg2(dobpdc), MAF-X25ox, FMOF-1, MAF-6, UiO-66-NH2@MON, ZIF-8, CAU-1, ZIF-67, MIL-68, MIL-101, UiO-67, UiO-66, [(C2H5)2NH2]2[Mn6(L)(OH)2(H2O)6]4DEF, [Zn(trz)(H2betc)0.5]DMF, PCN-100, NU-1000, FIR-53, FIR-54,Al-MIL-96, Fe-MIL-100, Al-MIL-100, Cr-MIL-100, Fe-MIL-53, Cr-MIL-53, UiO-66-NH2, InPCF-1, HKUST-1, ZIF-7, ZIF-9, CAU-6, H-ZIF-8-11, H-ZIF-8-12, H-ZIF-8-14, ZIF-8-MeOH, Al-MIL-53, Cr-MIL-101, Cu2L, PED-MIL-101, HM-MIL-101, MOF-235, UiO-67-OH, ZIF-25, ZIF-71, ZIF-93, ZIF-96, ZIF-97.

The MOF may be selected from one or more of Co-MOF-74, [Zn4(u4-O)-(u4-4-carboxy-3,5-dimethyl-4-carboxy-pyrazolato)3], PCP-33, NU-100, IRMOF-74-III-CH2NH2, Zn-pbdc-12a(bpe), mmen-Mg2(dobpdc), MAF-X25ox, FMOF-1, MAF-6, UiO-66-NH2@MON, ZIF-8, CAU-1, ZIF-67, MIL-68, MIL-101, UiO-67, UiO-66, [(C2H5)2NH2]2[Mn6(L)(OH)2(H2O)6]4DEF, [Zn(trz)(H2betc)0.5]DMF, PCN-100, NU-1000, FIR-53, FIR-54,Al-MIL-96, Fe-MIL-100, Al-MIL-100, Cr-MIL-100, Fe-MIL-53, Cr-MIL-53, UiO-66-NH2, InPCF-1, HKUST-1, ZIF-7, ZIF-9, CAU-6, H-ZIF-8-11, H-ZIF-8-12, H-ZIF-8-14, ZIF-8-MeOH, Al-MIL-53, Cr-MIL-101, Cu2L, PED-MIL-101, HM-MIL-101, MOF-235, UiO-67-OH, ZIF-25, ZIF-71, ZIF-93, ZIF-96, ZIF-97, for example one or more of ZIF-25, ZIF-71, ZIF-93, ZIF-96, ZIF-97, preferably for desalination membranes.

Suitably, the MOF is selected from one or more of Zr-DUT-51, Hf-DUT-51, PCN-777, NU-1105, DUT-52, DUT-53, DUT-84, DUT-67, DUT-68, DUT-69, DUT-6, such as MIL-125 (Fe, Cr, Al, V), MIL-53 (Fe, Cr, Al, V), MIL-47(Fe, Cr, Al, V), UAM-150, UAM-151, UAM-152, Zr(O3PC12H8PO3), Zr Bipyridylphosphonates, Zr Methylphosphonates, Sn(IV) Bipyridylphosphonates, Sn(IV) Methylphosphonates, [Ag(4-biphenylsulfonate)]^{∞}, [Ag(2-naphthalenesulfonate)]^{∞}, [Ag(H2O)0.5(1-naphthalenesulfonate)]^{∞}, [Ag(1-naphthalenesulfonate)]^{∞}and [Ag(1-pyrenesulfonate)]^{∞}, UO₂(O₃PC₆H₅)₃0.7H₂O, (UO₂)₃(HOPC₆H₅)₂—(O₃PC₆H₅)₂3H₂O, SAT-16, SAT-12 (Mn²⁺, Fe²⁺, Co²⁺, Ni²⁺), MIL-91 (Al³⁺, Fe³⁺, In³⁺, V³⁺), STA-13 (Y³⁺, Sc³⁺, Yb³⁺, Dy³⁺), VSN-3 (with —CH₂—units ranging from 1 to 10) , VSB-4 (with —CH₂— units ranging from 1 to 10), ZIF-95, ZIF-100, M3(btp)₂ (M=Ni,Cu, Zn, and Co; H3btp=1,3,5-tris(1H-pyrazol-4-yl)benzene), IRMOF-76, IRMOF-77, PCM-18, MOF-1040, MOF-253_0.08PdCl₂, MOF-253_0.83PdCl₂, MOF-253_0.97Cu(BF₄)₂, NOTT-115, UMCM-150, UMCM-154, MOF-5, FJI-1, MOF-100, MOF-177, MOF-210, UMCM-1, UMCM-2, UMCM-3, UMCM-4, UMCM-8, UMCM-9, MTV-MOF-5, L6-L11; PCN-80, UNLPF-1, NOTT-140, UTSA-34a, UTSA-34b, MODF-1, SDU-1, NPG-5, UTSA-20, NU-100, NU-110E, PCN-61, PCN-66, PCN-69, PCN-610, DUT-49, PCN-88, NOTT-300, NOTT-202, NOTT-104, PCN-46, PCN-14, NOTT-100, NOTT-101, NOTT-103, NOTT-109, NOTT-111, ZSA-1, ZSA-2, NOTT-12, NOTT-16, POMF-Cu ([Cu₂₄L₈(H₂O)₂₄], MIL-59, PCN-12, PCN-12′, DUT-75, DUT-76, PCN-16, PCN-16′, PCN-511, IMP-11, PCN-512, IMP-9, MOF-11, MOF-36, Hf-PCN-523, PCN-521, MOF-177, MOF-180, MOF-200, SNU-150, MOF-14, MOF-143, MOF-388, MOF-399, UiO-88, MOF-1001, IRMOF-62, MOF-101, IRMOF-74, CAU-10-OH, CAU-10-NH₂, CAU-10-H, CAU-10-CH₃, CAU-10, CALF-25, Zn-DMOF, Co-DMOF, DUT-4, SAPO-34, SBA-15, HZSM-5, MCM-41, KIT-1, MCM-48, Zn-MOF-74, Ni-MOF-74, Mg-MOF-74, PCN-228, PCN-229, PCN-230, MOF-808, MIL-160, MIL-163, FJI-H6, [Zr6O4(OH)4(btba)3](DMF)x(H2O)y, wherein x is 0 to <20 and y is 0 to <20, FJI-H7, lanthanide element-based [La(pyzdc)1.5(H2O)2]2H2O, [Dy(Cmdcp)(H2O)3](NO3)2H2O)n, [Eu(HL)(H2O)2]n2H2O, Tb-DSOA, [Tb(L)(OH)]x(slov), ([Tb(L1)1.5(H2O)]3H2O, In-based JLU-Liu18, Al-based MIL-121, MAF-6, MAF-7, MAF-49, MAF-X8, [Zn12(trz)20][SiW12O40]11H2O, Zn2TCS(4′4-bipy), Zn-pbdc-11a(bpe)/-12a(bpe)/-12a(bpy), Zn(IM)1.5(abIM)0.5, ([Zn(C10H2O8)0.5(C10S2N2H8)]5H2O))n, Co/Zn-BTTBBPY, PCN-601, Mg-CU K-1, [Cd2(TBA)2(bipy)(DMA)2], Cu6(trz)10(H2O)4[H2SiW12O40}8H2O, [Ni(BPEB)], [Eu3(bpydb)3(HCOO)(u3-OH)2(DMF)](DMF)3(H2O)2, MAF-X25, MAF-X27, MAF-X25ox, MAF-27ox, PCN-101, NH2-MIL-125(Ti), Cu(I)-MOF, AEMOF-1, PCN-222, Cd-EDDA, [Cd2L2]NMPMEOH, Eu/UiO-66-(COOH)2, Eu/CPM-17-Zn, Eu/MIL-53-COOH(Al), [Ln(HL)(H2O)2]n2H2O, Eu3+@MIL-124, ([Tb(L1)1.5(H2O)]3H2O)n, [Tb(I)(OH)]x(solv), bio-MOF-1, BFMOF-1, NENU-500, Co-ZIF-9, Al2(OH)2TCPP-Co, Al-MIL-101-NH-Gly-Pro, UiO-66-CAT, Pt/UiO-66, HPW@MIL-101, POM-ionic-liquid-functionalized MIL-100, sulphated MIL-53, MIL-101(Cr)-NO2, NENU-1/12-tungstosilicic acid, Na-HPAA, PCMOF-10, Ca-PiPhtA, (NH4)2(adp)[Zn2(ox)3]3H2O, ([Zn(C10H2O8)0.5(C10S2N2H8)]5H2O])n, ([(Me2NH2]3(SO4))2[Zn2(ox)3])n, UiO-66-(SO3H)2, Tb-DSOA, [La3L4(H2O)6]ClxH2O, CALF-25, (Cu212)[Cu2PDC2-(H2O)2]2[Cu(MeCN)4]IDMF, (Cu414)[Cu2PDC2-(H2O)2]4DMF, (Cu212)[Cu3PDC3-(H2O)2]2MeCN)2DMF, ZIF-1, ZIF-3, ZIF-4, ZIF-6, ZIF-10, ZIF-11, ZIF-12, ZIF-14, ZIF-20, ZIF-22, ZIF-9-67, ZIF-60, ZIF-67, ZIF-68, ZIF-69, ZIF-74, ZIF-76, ZIF-77, ZIF-78, ZIF-79, ZIF-80, ZIF-81, ZIF-82, ZIF-90, ZIF-95, ZIF-100, UiO-68., MOF-801, MOF-841, [Co4L3(u3-OH)(H2O)3](SO4)0.5, MOF-802, Cu-BTTri, PCN-426, MOF-545, Zn(1,3-BDP), [(CH3)2NH2]2[Eu6(u3-OH)8(1,4-NCD)6(H2O)6], NiDOBDC, Al(OH)(2,6-ndc) (ndc is naphthalendicarboxylate), MOF-525, MOF-535.

The MOF may be selected from one or more of zeolitic imidazolate frameworks (ZIFs), suitably a ZIF formed from a metal salt of Zn, Co, Cd, Li, or B, with an imidazole based linker, such as ZIF-1, ZIF-3, ZIF-4, ZIF-6, ZIF-10, ZIF-11, ZIF-12, ZIF-14, ZIF-20, ZIF-22, ZIF-9-67, ZIF-60, ZIF-67, ZIF-68, ZIF-69, ZIF-74, ZIF-76, ZIF-77, ZIF-78, ZIF-79, ZIF-80, ZIF-81, ZIF-82, ZIF-90, ZIF-95, ZIF-100, ZIF-8, ZIF-9, H-ZIF-8-11, H-ZIF-8-12, H-ZIF-8-14, ZIF-8-MeOH, ZIF-25, ZIF-71, ZIF-93, ZIF-96, ZIF-97 and their derivatives. The MOF may be selected from one or more of ZIF-1, ZIF-3, ZIF-4, ZIF-6, ZIF-10, ZIF-11, ZIF-12, ZIF-14, ZIF-20, ZIF-22, ZIF-9-67, ZIF-60, ZIF-67, ZIF-68, ZIF-69, ZIF-74, ZIF-76, ZIF-77, ZIF-78, ZIF-79, ZIF-80, ZIF-81, ZIF-82, ZIF-90, ZIF-95, ZIF-100.

Advantageously, ZIFs have been found to provide robust chemical and thermal resistance and controllable porosity and pore sizes.

The ZIFs may be formed of repeating units of (M-Im-M), wherein M is Zn or Co, and Im is imidazole or a derivative thereof which bridges the metal units in a tetrahedral coordination.

The imidazole or its derivative unit may be selected from one or more of imidazole (ZIF-4 linker), 2-methylimidazole (ZIF 8 linker), 2-ethyl imidazole, 2-nitro imidazole, 4-isocyanoimidazole, 4,5-dichloroimidazole, imidazole-2-carbaldehyde, imidazo[4,5-b]pyridine, benzo[d]imidazole, 6-chloro-benzo[d]imidazole, 5,6-dimethyl-benzo[d]imidazole, 6-methyl-benzo[d]imidazole, 6-bromo-benzo[d]imidazole, 6-nitro-benzo[d]imidazole, imidazo[4,5-c]pyridine, purine.

Advantageously, ZIFs can be used for high temperature filtration application and provide high thermal stability, high strength and/or chemical resistance. For example, ZIF 8 can withstand temperatures of up to 550° C.

The MOF may be selected from one or more UiO MOFs, such as UiO-66, for example Eu/UiO-66-(COOH)2, UiO-66-CAT, Pt/UiO-66, UiO-66-(SO3H)2, UiO-67, UiO-68, UiO-88 and their derivatives. For example, the UIO-66 MOF may be Eu/UiO-66-(COOH)2, UiO-66-CAT, Pt/UiO-66, UiO-66-(SO3H)2. The MOF may comprise UiO-68 or UiO-88.

Advantageously, UiO MOFs have been found to provide robust properties, such as high chemical and thermal stability, high mechanical strength, and/or large surface area. For instance, the thermal stability temperature is at least 200° C. UiO MOFs are Zr based. The UiO MOF may be zirconium 1,4-dicarboxybenzne MOF (UiO 66) which may be comprised of Zr6O4(OH)4, octahedral, 12-fold connected to adjacent octahedra through a 1,4-benzene-dicarboxylate (BDC) linker. The UiO MOF may alternatively/additionally be selected from one or more of UiO 66, zirconium aminobenzenedicarboxylate MOF (UiO-66-BDC-NH2), zirconium benzenedicarboylate (UiO-66-BDC), zirconium biphenyldicarboxylate MOF (UiO-66-BPD/UiO-67), zirconium fumarate MOF (UiO-66-FA, FA:Zr=0.66-0.98), zirconium trans-1,2-ethylenedicarboxylic acid MOF (UiO-66-FA, FA:Zr=1), zirconium trimellitate MOF (UiO-66-BDC-COON, BDC-COOH:Zr=0.9-1.0).

The MOF may be selected from one or more of MOF-74, such as Zn-MOF-74, Ni-MOF-74, Mg-MOF-74.

The MOF may be selected from one or more of Cu-BTTri, MIL-53 (Al), MIL-101(Cr), PCN-426-Cr(III), [(CH₃)2NH2]2[Eu6(u3-OH)8(1,4-NCD)6(H2O)6], Zn(1,3-BDP), MOF-808, DUT-69, DUT-67, DUT-68, PCN-230, PCN-222, MOF-545, MOF-802, and HKUST-1. Suitably, the MOF is selected from one or more of MOF-808, PCN-230, PCN-222 and HKUST-1, preferably one or more of MOF-808, PCN-230, PCN-222.

The active layer may be operable to provide size exclusion filtration, fouling resistance, and/or adsorption, such as size exclusion and fouling resistance.

The pore size of the MOF may be tailored by using different species of MOFs or different organic linkers with different lengths. For example, the pore size of the MOF may be at least 0.6 nm (e.g. ZIF-78), such as at least 0.8 nm (e.g. ZIF-81), or at least 0.9 nm (e.g. ZIF-79) or at least 1.2 nm (e.g. ZIF-69), or at least 1.3 nm (e.g. ZIF-68) or at least 1.6 nm (e.g. ZIF-82), such as at least 1.8 nm (e.g. ZIF-70), or at least 1.8 nm (e.g. IRMOF-10), or at least 2.8 nm (e.g. MOF-177).

The MOF may comprise MOF-74 adapted by replacing one or more of the original linkers containing one phenyl ring with a linker containing two, three, four, five, six, seven, nine, ten or eleven phenyl rings. Such an adaption can alter the pore size from ˜1.4 nm to ˜2.0nm, to ˜2.6nm, to ˜3.3nm, to ˜4.2nm, to ˜4.8nm, to ˜5.7nm, to ˜7.2nm, to ˜9.5 nm, respectively.

The MOF may be hydrophobic. The hydrophobic MOF may be selected from one or more of MIL-101(Cr), NiDOBDC, HKUST-1, Al(OH)(2,6-ndc) (ndc is naphthalendicarboxylate), MIL-100-Fe, UiO-66, ZIF family, such as ZIF 71, ZIF 74, ZIF-1, ZIF-4, ZIF-6, ZIF-11, ZIF-9, and ZIF 8. Advantageously, the use of such MOFs can improve the fouling resistance of the membrane.

The MOF may comprise an adsorption promoting MOF, for example UiO-66 or UiO-66-NH2, preferably UiO-66-NH2, which has been found to adsorb cationic dyes from aqueous solution more effectively than anionic dyes due to favourable electrostatic interactions between the adsorbents and cationic dyes. In particular, UiO-66-NH2 has been found to provide much higher adsorption capacity for cationic dyes and lower adsorption capacity for anionic dyes than UiO-66.

The MOFs may comprise nanochannels, suitably the MOFs are in the form of flakes or particles comprising nanochannels. The average nanochannel diameter may be from 0.2 nm to 100 nm, such as between 0.2 to 90 nm, 0.3 nm to 75 nm, 0.4 nm to 50 nm, for example 0.5 nm to 40 nm, 0.5 nm to 30 nm, or 0.5 nm to 20 nm, suitably 0.5 nm to 15 nm, 0.5 nm to 10 nm or preferably 0.5 nm to 8 nm.

The MOF may be a zirconium based MOF, such as UiO-66 (Zr), UiO-67 (Zr), and UiO-68 (Zr), MOF-525 (Zr6O4(OH)4(TCPP-H2)3, MOF-535 (Zr6O4(OH)4(XF)3, and MOF 545 (Zr6O8(H2O)8(TCPP-H2)2, where porphyrin H4-TCPP-H2=(C48H24O8N4) and cruciform H4-XF=(C42O8H22), preferably UiO-68 (Zr) or MOF-525, most preferably UiO-68. Said MOFs have been found to show exceptional stability against chemicals, temperature and mechanical stress. The structure of said MOFs may comprise Zr6O4(OH)4 cluster subunits as nodes and organic linkers such as benzene 1,4-dicarboxylate liner.

The MOF may comprise functional groups selected from one or more of amine, aldehyde, alkynes, and/or azide. MOFs pores may be modified for selective sieving and to provide higher efficiency by modification methods, suitably post-synthetic, on the linkers and/or the secondary building units/nodes, such as covalent post-synthetic modification method of amine, or aldehyde, or alkynes, or azides functional groups. Specific functional groups may be induced to MOF(s) for specific application. For example, adding —NH2 to UiO-66 to make UiO-66-NH2 has been found to improve ferric acid adsorption, and adding sulfone bearing groups to iso IRMOF-16 by, for example, oxidation using dimethyldioxirane, in order to create compatible interaction between the active layer and first support portion.

The MOFs of the present invention may be synthesised according to the required property or purchased from commercial supplier. Suitable commercially available metal-organic framework materials can be purchased from BASF, Sigma-Aldrich, or Strem Chemicals.

The methods used to synthesise MOFs for the current invention are those conventional in the art and may be solvothermal synthesis, microwave-assisted synthesis, electrochemical synthesis etc.

A modulator may be used during synthesis of the MOF to control the MOF particle size, the modulator may be benzoic acid.

The MOF may be in the form of a crystallised continuous phase or particles or flakes compacted and interacting or fused to each other forming the active layer. Preferably the MOF is in the form of particles or flakes.

The size distribution of the MOF flakes or particles may be such that at least 30 wt % of the MOF flakes or particles have a size of between 1 nm to 10000 nm, such as between 2 to 7500 nm, 5 nm to 5000 nm, 10 nm to 4000 nm, for example 15 nm to 3500 nm, 20 nm to 3000 nm, or 25 nm to 3000 nm, suitably 30 nm to 2500 nm, 40 nm to 2500 nm or preferably 50 nm to 2500 nm more preferably at least 40 wt %, 50 wt %, 60 wt %, 70 wt % and most preferably at least 80 wt % or at least 90 wt % or 95 wt % or 98 wt % or 99 wt %. The size of the MOF and size distribution may be measured using transmission electron microscopy (TEM, JEM-2100F, JEOL Ltd. Japan).

For example, lateral sizes of two-dimensional layers across a sample of a MOF may be measured using transmission electron microscopy (TEM, JEM-2100F, JEOL Ltd. Japan), and the number (Nᵢ) of the same sized nanosheets (Mᵢ) measured. The average size may then be calculated by Equation 1:

Average size=Σᵢ₌₁^{∞}NᵢMᵢ/Σᵢ₌₁^{∞}Nᵢ

where M, is diameter of the nanosheets, and Nᵢ is the number of the size with diameter Mᵢ.

The active layer may comprise materials, suitably two-dimensional materials, other than a MOF. For example, other materials of the active layer may be selected from one or more of transition metal dichalcogenide, silicene, germanene, stanene, boron-nitride, suitably h-boron nitride, carbon nitride, transition metal dichalcogenide, graphene, graphene oxide, reduced graphene oxide functionalised graphene oxide and polymer/graphene aerogel.

The active layer may comprise additives to tailor the properties of the active layer, such as other metals; and/or fibres, such as metal oxide nanostrands; and/or dopants such as Au, Fe, Cu, Cu(OH)₂, Cd(OH)₂ and/or Zr(OH)₂. Such additives may be added to the membrane to control the pore sizes and channel architecture of MOF and/or create nanochannels for high water flux rate. Any type of suitable fibres, such as continuous or stapled fibres, having diameter of 0.1-1000 nm may be incorporated within the membrane. Such as 0.1 to 850 nm, 0.5 to 500 nm, or 0.5 to 100 nm, 0.75 to 75 nm, preferably, 0.75 to 50 nm. Suitably, the fibres are removed before use, such as by mechanical removal or by dissolution, etc.

The method of applying the active layer coating composition to the membrane device may comprise the step of applying a coating composition comprising the MOF onto the first support portion. The method may comprise contacting the coating composition onto the first support portion using gravity deposition, vacuum deposition, pressure deposition; printing such as inkjet printing, aerosol printing, 3D printing, offset lithography printing, gravure printing, flexographic printing techniques, pad printing; curtain coating, dip coating, spin coating, and other printing or coating techniques known to those skilled in the art.

Further details of the application methods are disclosed in published PCT patent application WO2019/186134, specifically, paragraphs [117], [118] and [126] to [130] inclusive. The entire contents paragraphs [117], [118] and [126] to [130] inclusive thereof are fully incorporated herein by reference.

The active layer coating composition may be a liquid composition comprising a liquid medium and one or more of MOF(s). The coating compositions of the present invention may comprise solvent, non-solvent or be solvent-less, and may be UV curable compositions, e-beam curable compositions etc.

The coating composition may comprise MOF precursors, such as one or more of a SBU or node precursor, suitably in the form of a salt, and organic ligand or precursor thereof. The coating composition may comprise, or be formed from a salt precursor of any type of compound that could be used to synthesise a MOF SBU or node, such a metal salt, for example one or more of an aluminium salt, ammonium salt, antimony salt, arsenic salt, barium salt, beryllium salt, bismuth salt, cadmium salt, calcium salt, cerium salt, caesium salt, chromium salt, cobalt salt, copper salt, dysprosium salt, erbium salt, europium salt, gadolinium salt, gallium salt, germanium salt, gold salt, hafnium salt, holmium salt, indium salt, iridium salt, iron salt, lanthanum salt, lead salt, lithium salt, lutetium salt, magnesium salt, manganese salt, mercury salt, molybdenum salt, neodymium salt, nickel salt, niobium salt, osmium salt, palladium salt, platinum salt, potassium salt, praseodymium salt, rhenium salt, rhodium salt, rubidium salt, ruthenium salt, samarium salt, scandium salt, selenium salt, silver salt, sodium salt, strontium salt, sulfur salt, tantalum salt, tellurium salt, terbium salt, thallium salt, thorium salt, thulium salt, tin salt, titanium salt, tungsten salt, vanadium salt, ytterbium salt, yttrium salt, zinc salt, zirconium salt.

The organic ligand precursor may include any type of organic ligand that could be used to synthesise a MOF, such as any one of the organic linkers listed above.

Further details of the active layer composition are disclosed in published PCT patent application WO2019/186134, specifically, paragraphs [97] to [116] inclusive. The entire contents paragraphs [97] to [116] inclusive thereof are fully incorporated herein by reference.

The active layer may have a thickness of from 2 nm to 1000 nm, such as from 3 to 800 nm or from 4 to 600 nm, such as 5 to 400 nm or 5 to 200 nm, preferably 5 to 150 nm or 5 to 100 nm.

The membrane device may comprise two or more discrete portions of active layers on the first support portion.

The active layer may further comprise nanochannels formed by the use of fibres in the production of the membrane. Advantageously the presence of nanochannels within the active layers have been found to significantly increase the water flux by incorporating continuous or chopped fibres having diameter of 0.5-1000 nm during the manufacture process followed by removal of the fibres.

The nanochannels in the active layer may have a diameter of 1 to 750 nm, such as 1 to 500 nm, or 1 to 250 nm, for example 1 to 150 nm or 1 to 100 nm, for example 1 to 50 nm or 1 to 25 nm, such as 1 to 10 nm or preferably 1 to 5 nm.

The membrane device may be used in the treatment and separation of water from contaminants.

The membrane device may be used in chemical separation, protein separation, produced water treatment or industrial wastewater treatment that requires high temperature operation and/or harsh pH environments.

The term “shelled” referred to herein, means hollowed solid parts of a structure with a given wall thickness.

The membrane device of the present invention may be produced by:
a. additively manufacturing the porous ceramic member to produce the lattice structure of the second support portion and to form the first support portion;
b. optionally, removing binder from the first support portion to form pores in the first support portion;
c. optionally, applying an active layer to at least a portion of the first support portion, suitably by coating an active layer composition onto the first support portion.

In step (a) the macrostructure of the first support portion may be formed but the pore structure of the first support portion may be formed in step (b). In such a process, step (a) may be considered to be the formation of the green part. Step (b) may be considered to be a de-binding and/or sintering step.

Advantageously, the first and/or second support portion may be produced, suitably printed, using an additive manufacturing process, preferably, the first and second support portions are additively manufactured so as to form an integral support structure. The additive manufacturing technique may be any suitable ceramic 3D printing technology. For example, the first and/or second support portion may be printed using binder jet printing, stereolithography, digital light processing, two-photon polymerisation, inkjet printing, direct ink writing, three-dimensional printing, selective laser sintering, selective laser melting, laminated object manufacturing, or fused deposition modelling.

The additive manufacture of the porous ceramic member provides a membrane device with the mechanical strength required to support an active layer during manufacture and filtration, whilst also balancing the high porosity and increased packing density to provide improved fluid flow during the final filter application.

In the membrane device of the present invention, pressure is used to push the water through the active layer where contaminates are separated out and left in the water feed and uncontaminated water passes through onto the permeate side, where it is pushed through the porous ceramic member towards an exit of the membrane device.

The term “lamellar structure” herein means a structure having at least two overlapping layers. The term “active layer” or “membrane” herein means a porous barrier operable to separate the desired dissolved materials (solutes), colloids or particulates from the feed solutions. It may represent the interface between the feed flow and the permeate flow. The term “two-dimensional material” herein means a material with at least one dimension of less than 100 nm.

For the purpose of the present invention, an aliphatic group is a hydrocarbon moiety that may be straight chain (i.e. unbranched), branched, or cyclic and may be completely saturated, or contain one or more units of unsaturation, but which is not aromatic. The term “unsaturated” means a moiety that has one or more double and/or triple bonds. The term “aliphatic” is therefore intended to encompass alkyl, cycloalkyl, alkenyl cycloalkenyl, alkynyl or cycloalkenyl groups, and combinations thereof. The term “(hetero)aliphatic” encompasses both an aliphatic group and/or a heteroaliphatic group.

An aliphatic group is optionally a C₁₋₃₀ aliphatic group, that is, an aliphatic group with 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 carbon atoms. Optionally, an aliphatic group is a C₁₋₁₅ aliphatic, optionally a C₁₋₁₂ aliphatic, optionally a C₁₋₁₀ aliphatic, optionally a C₁₋₈ aliphatic, such as a C₁₋₆ aliphatic group. Suitable aliphatic groups include linear or branched, alkyl, alkenyl and alkynyl groups, and mixtures thereof such as (cycloalkyl)alkyl groups, (cycloalkenyl)alkyl groups and (cycloalkyl)alkenyl groups.

The term “alkyl,” as used herein, refers to saturated, straight- or branched-chain hydrocarbon radicals derived by removal of a single hydrogen atom from an aliphatic moiety. An alkyl group is optionally a “C₁₋₂₀ alkyl group”, that is an alkyl group that is a straight or branched chain with 1 to 20 carbons. The alkyl group therefore has 1, 2, 3, 4, 5, 6, 7, 8, 9, 10, 11, 12, 13, 14, 15, 16, 17, 18, 19 or 20 carbon atoms. Optionally, an alkyl group is a C₁₋₁₅ alkyl, optionally a C₁₋₁₂ alkyl, optionally a C₁₋₁₀ alkyl, optionally a C₁₋₈ alkyl, optionally a C₁₋₆ alkyl group. Specifically, examples of “C₁₋₂₀ alkyl group” include methyl group, ethyl group, n-propyl group, iso-propyl group, n-butyl group, iso-butyl group, sec-butyl group, tert-butyl group, sec-pentyl, iso-pentyl, n-pentyl group, neopentyl, n-hexyl group, sec-hexyl, n-heptyl group, n-octyl group, n-nonyl group, n-decyl group, n-undecyl group, n-dodecyl group, n-tridecyl group, n-tetradecyl group, n-pentadecyl group, n-hexadecyl group, n-heptadecyl group, n-octadecyl group, n-nonadecyl group, n-eicosyl group, 1,1-dimethylpropyl group, 1,2-dimethylpropyl group, 2,2-dimethylpropyl group, 1-ethylpropyl group, n-hexyl group, 1-ethyl-2-methylpropyl group, 1,1,2-trimethylpropyl group, 1-ethylbutyl group, 1-methylbutyl group, 2-methylbutyl group, 1,1-dimethylbutyl group, 1,2-dimethylbutyl group, 2,2-dimethylbutyl group, 1,3-dimethylbutyl group, 2,3-dimethylbutyl group, 2-ethylbutyl group, 2-methylpentyl group, 3-methylpentyl group and the like.

The term “alkenyl,” as used herein, denotes a group derived from the removal of a single hydrogen atom from a straight- or branched-chain aliphatic moiety having at least one carbon-carbon double bond. The term “alkynyl,” as used herein, refers to a group derived from the removal of a single hydrogen atom from a straight- or branched-chain aliphatic moiety having at least one carbon-carbon triple bond. Alkenyl and alkynyl groups are optionally “C₂₋₂₀alkenyl” and “C₂₋₂₀alkynyl”, optionally “C₂₋₁₅ alkenyl” and “C₂₋₁₅ alkynyl”, optionally “C₂₋₁₂ alkenyl” and “C₂₋₁₂ alkynyl”, optionally “C₂₋₁₀ alkenyl” and “C₂₋₁₀ alkynyl”, optionally “C₂₋₈ alkenyl” and “C₂₋₈ alkynyl”, optionally “C₂₋₆ alkenyl” and “C₂₋₆ alkynyl” groups, respectively. Examples of alkenyl groups include ethenyl, propenyl, allyl, 1,3-butadienyl, butenyl, 1-methyl-2-buten-1-yl, allyl, 1,3-butadienyl and allenyl. Examples of alkynyl groups include ethynyl, 2-propynyl (propargyl) and 1-propynyl.

The terms “cycloaliphatic”, “carbocycle”, or “carbocyclic” as used herein refer to a saturated or partially unsaturated cyclic aliphatic monocyclic or polycyclic (including fused, bridging and spiro-fused) ring system which has from 3 to 20 carbon atoms, that is an alicyclic group with 3, 4, 5, 6, 7, 8, 9, 10, 11, 12, 13, 14, 15, 16, 17, 18, 19 or 20 carbon atoms. Optionally, an alicyclic group has from 3 to 15, optionally from 3 to 12, optionally from 3 to 10, optionally from 3 to 8 carbon atoms, optionally from 3 to 6 carbons atoms. The terms “cycloaliphatic”, “carbocycle” or “carbocyclic” also include aliphatic rings that are fused to one or more aromatic or nonaromatic rings, such as tetrahydronaphthyl rings, where the point of attachment is on the aliphatic ring. A carbocyclic group may be polycyclic, e.g. bicyclic or tricyclic. It will be appreciated that the alicyclic group may comprise an alicyclic ring bearing one or more linking or non-linking alkyl substituents, such as —CH₂-cyclohexyl. Specifically, examples of carbocycles include cyclopropane, cyclobutane, cyclopentane, cyclohexane, bicycle[2,2,1]heptane, norborene, phenyl, cyclohexene, naphthalene, spiro[4.5]decane, cycloheptane, adamantane and cyclooctane.

A heteroaliphatic group (including heteroalkyl, heteroalkenyl and heteroalkynyl) is an aliphatic group as described above, which additionally contains one or more heteroatoms. Heteroaliphatic groups therefore optionally contain from 2 to 21 atoms, optionally from 2 to 16 atoms, optionally from 2 to 13 atoms, optionally from 2 to 11 atoms, optionally from 2 to 9 atoms, optionally from 2 to 7 atoms, wherein at least one atom is a carbon atom. Optional heteroatoms are selected from O, S, N, P and Si. When heteroaliphatic groups have two or more heteroatoms, the heteroatoms may be the same or different. Heteroaliphatic groups may be substituted or unsubstituted, branched or unbranched, cyclic or acyclic, and include saturated, unsaturated or partially unsaturated groups.

An alicyclic group is a saturated or partially unsaturated cyclic aliphatic monocyclic or polycyclic (including fused, bridging and spiro-fused) ring system which has from 3 to 20 carbon atoms, that is an alicyclic group with 3, 4, 5, 6, 7, 8, 9, 10, 11, 12, 13, 14, 15, 16, 17, 18, 19 or 20 carbon atoms. Optionally, an alicyclic group has from 3 to 15, optionally from 3 to 12, optionally from 3 to 10, optionally from 3 to 8 carbon atoms, optionally from 3 to 6 carbons atoms. The term “alicyclic” encompasses cycloalkyl, cycloalkenyl and cycloalkynyl groups. It will be appreciated that the alicyclic group may comprise an alicyclic ring bearing one or more linking or non-linking alkyl substituents, such as —CH₂-cyclohexyl. Specifically, examples of the C₃₋₂₀ cycloalkyl group include cyclopropyl, cyclobutyl, cyclopentyl, cyclohexyl, cycloheptyl, adamantyl and cyclooctyl.

An aryl group or aryl ring is a monocyclic or polycyclic ring system having from 5 to 20 carbon atoms, wherein at least one ring in the system is aromatic and wherein each ring in the system contains three to twelve ring members. An aryl group is optionally a “C₆₋₁₂ aryl group” and is an aryl group constituted by 6, 7, 8, 9, 10, 11 or 12 carbon atoms and includes condensed ring groups such as monocyclic ring group, or bicyclic ring group and the like. Specifically, examples of “C₆₋₁₀ aryl group” include phenyl group, biphenyl group, indenyl group, anthracyl group, naphthyl group or azulenyl group and the like. It should be noted that condensed rings such as indan, benzofuran, phthalimide, phenanthridine and tetrahydro naphthalene are also included in the aryl group.

As used herein, unless otherwise expressly specified, all numbers such as those expressing values, ranges, amounts or percentages may be read as if prefaced by the word “about”, even if the term does not expressly appear. The term “about” when used herein means +/31 10% of the stated value. Also, any numerical range recited herein is intended to include all sub-ranges subsumed therein. Singular encompasses plural and vice versa. For example, although reference is made herein to “a” porous ceramic member, “a” support member, “a” filter member, and the like, one or more of each of these and any other components can be used. As used herein, the term “polymer” refers to oligomers and both homopolymers and copolymers, and the prefix “poly” refers to two or more. Including, for example and like terms means including for example but not limited to. Additionally, although the present invention has been described in terms of “comprising”, the processes, materials, and coating compositions detailed herein may also be described as “consisting essentially of” or “consisting of”.

Where ranges are provided in relation to a genus, each range may also apply additionally and independently to any one or more of the listed species of that genus.

All of the features contained herein may be combined with any of the above aspects in any combination.

For a better understanding of the invention, and to show how embodiments of the same may be carried into effect, reference will now be made, by way of example, to the following experimental data.

### BRIEF DESCRIPTION OF DRAWINGS

The invention will now be described by way of example only and with reference to the accompanying drawings, in which:

FIG. 1 shows the extrusion process for creating the ceramic membrane device of Comparative example 1.

FIG. 2 shows the membrane device of Comparative Example 1.

FIG. 3 shows the membrane device of Example 1.

FIG. 4 shows the membrane device of Example 2.

FIG. 5 shows the membrane device of Example 3 having a non-uniform gyroid lattice structure along one axis and also an example of a uniform gyroid for comparison.

### EXAMPLES

### Comparative Example 1

As shown in FIG. 1, Comparative Example 1 is formed by a prior art method to prepare a channelled ceramic membrane device by applying an extrusion process using a mixture of alumina 100, pore former 102 and a binder. The mixture enters the extruder and is extruded into the membrane device with a fixed shape under pressure. The membrane device is cut to length and sintered.

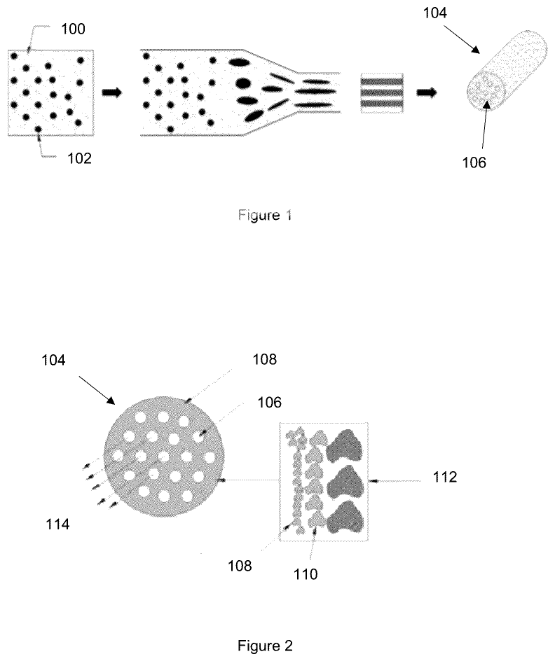

As shown in FIG. 2, the comparative membrane device produced 104 is of a generally cylindrical shape having a plurality of spaced cylindrical linear parallel feed flow channels 106 extending longitudinally through the support body 108 of the membrane device. The channels are surrounded along their length by a support body 108, which spaces the channels. The inner surface of the feed flow channels 106 comprises an active layer 108 coated thereon. Underneath the active layer 108 is transition layer 110. Supporting the transition layer 108 and the active layer 110 is a support portion 112. Support portion 112 is formed of a non-lattice irregular structure. In use, feed flow 114 passes down the feed flow channels and the desired permeate passes through the active layer 108 and the transition layer 110 into the support portion 112 of support body 108 to then flow out of the membrane device 104.

The feed flow channels of the membrane device of Comparative Example 1 have a diameter of 2.6 mm, an average channel pitch of 4.65 mm with a distance between the narrowest points of adjacent feed flow channels of 2.1 mm.

Comparative membrane device 104 has an average thickness of 2.1 mm between adjacent channels 106 and a packing density of ≤350 m²/m³.

Example 1

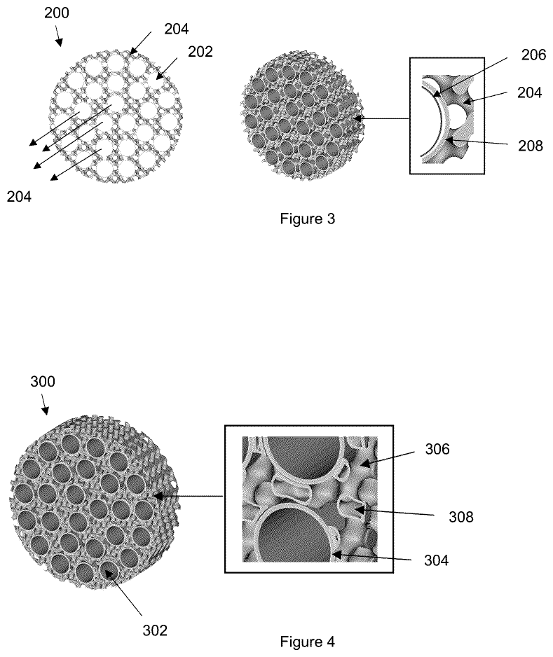

As shown in FIG. 3, the ceramic membrane device 200 of Example 1 has a similar macrostructure to the membrane device of Comparative Example 1, with a plurality of spaced cylindrical linear parallel feed flow channels 202 surrounded and spaced by a support body 204. In the membrane device 200 of Example 1, the channels 202 are formed of thin walled first support portions that have an average thickness of 0.2 mm. The membrane device of Example 1 has a feed flow diameter of 2.6 mm, an average channel pitch of 4 mm and a distance between the narrowest points of adjacent feed flow channels of 1.4 mm.

The feed flow channels 202 have a coating of an active layer 206 on the internal surface, which is supported by a first support portion 208, which is in turn supported by a second support portion 204. The second support portion 204 has a gyroid lattice structure with cell size of 3 mm.

The feed flow channels 202 of the membrane device of Example 1 can be stacked more closely, increasing the membrane surface packing density. The membrane device of Example 1 provides a porosity percentage of ≥40% with a packing density of ≥350 m²/m³, and has a tensile strength that can withstand feed application pressure of ≥100 kPa (1 bar)

The membrane device of Example 1 was produced by additive manufacturing of a composition comprising alumina and a binder into the predetermined macrostructure of the first support and the specific lattice structure of the second support portion to form a porous ceramic member. After manufacture, the porous ceramic member was post-processed to remove the binder to form pores in the first support portion and an active layer was applied to the internal surface of the channels on top of the first support portion.

### Example 2

As shown in FIG. 4, the ceramic membrane device 300 of Example 2 is the same as Example 1, having feed flow channels 302 formed by a first support portion 304 and a second support portion 306, except that the second support portion 306 has a shelled gyroid structure to provide a series of interconnected voids 308 giving an additional route for permeate flow while not compromising the structure's ability to withstand a feed application pressure of greater than 1 bar. In this embodiment the porosity has also increased compared to Example 1.

### Example 3

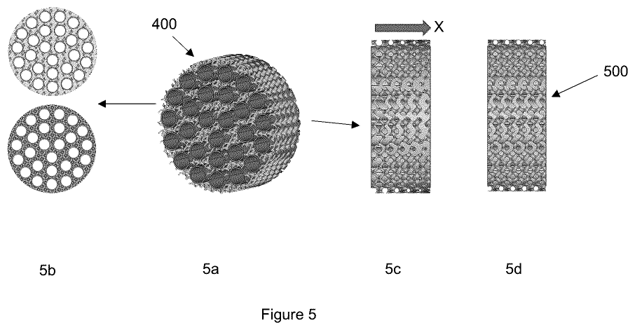

As shown in FIGS. 5a-d, the ceramic membrane device 400 of Example 3 is the same as the membrane device of Example 1, except that the second support portion of the membrane device of Example 3 is formed of a non-uniform lattcie structure. The direction of non-uniformity is shown in the side view of FIG. 5a along direction X. For comparision, a side view of a membrane device 500 having a uniform lattice structure is shown in FIG. 5d. The membrane device of Example 3 provides better flux by promoting turbulence, change in pressure and/or velocity in the liquid feed or permeate flow path.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A membrane device comprising a porous ceramic member, wherein the porous ceramic member comprises a first support portion operable to support an active layer and further comprises a second support portion,
wherein the second support portion has a higher D₇₅ average pore size than the D₇₅ average pore size of the first support portion,
wherein the second support portion comprises a lattice structure that has a porosity percentage of ≥40%, and
wherein the porous ceramic member has a tensile strength operable to withstand feed application pressure of ≥100 kPa (1 bar).

2. The membrane device according to claim 1, further comprising an active layer that extends across at least a part of the first support portion.

3. The membrane device according to claim 1, wherein the lattice is at least partially shelled to form an internal hollow structure.

4. The membrane device according to claim 1, wherein the lattice structure comprises a diamond structure, a cubic structure, a fluorite structure, an octet structure, a Kelvin cell structure, an iso-truss structure, a hex prism diamond structure, a truncated tube structure, a truncated octahedron structure, a Weaire-Phelan structure, a body centred cubic structure, a face centred cubic structure, a gyroid structure, a schwarz P structure, a schwarz D structure, a schwarz CLP structure, a schwarz H structure, a splitP structure, a neovius structure, and/or a double gyroid structure

5. (canceled)

6. The membrane device according to claim 1, wherein the second support portion is operable to produce a substantially laminar flow towards a permeate collection point.

7. The membrane device according to claim 1, wherein the second support portion comprises turbulent flow paths.

8. The membrane device according to claim 1, wherein the second support portion comprises a non-uniform lattice structure.

9. The membrane device according to claim 1, wherein the second support portion is macroporous.

10. (canceled)

11. (canceled)

12. The membrane device according to claim 1, wherein the D₇₅ average size of the pores of the first support portion is from 1 to 20 μm.

13. (canceled)

14. (canceled)

15. (canceled)

16. The membrane device according to claim 1, wherein the first support portion and the second support portion are integrally formed.

17. The membrane device according to claim 1, wherein the porous ceramic member has a surface roughness, suitably Rz, of from 0 to 1 μm.

18. The membrane device according to claim 1, wherein the membrane device comprises at least two feed flow channels that are at least partially spaced by the porous ceramic member.

19. The membrane device according to claim 18, wherein the at least two flow channels each comprise a channel wall formed at least partially of the first support portion.

20. (canceled)

21. (canceled)

22. (canceled)

23. (canceled)

24. (canceled)

25. (canceled)

26. (canceled)

27. (canceled)

28. (canceled)

29. (canceled)

30. The membrane device according to claim 1, wherein the device has a membrane packing density of ≥200 m²/m³.

31. The membrane device according to claim 2, wherein the active layer comprises a lamellar structure comprising at least two layers of two-dimensional material.

32. The membrane device according to claim 2, wherein the active layer comprises a transition metal dichalcogenide (TMD), graphene or a derivative thereof, and/or a metal-organic framework (MOF).

33. (canceled)

34. (canceled)

35. (canceled)

36. A water-treatment membrane device comprising a porous ceramic member according to claim 1.

37. A method of preparing a membrane device of claim 1, comprising:
a. additively manufacturing the porous ceramic member to produce the lattice structure of the second support portion and to form the first support portion.

38. The method according to claim 37, wherein the first and/or second support portion is produced using binder jet printing, stereolithography, digital light processing, two-photon polymerisation, inkjet printing, direct ink writing, three-dimensional printing, selective laser sintering, selective laser melting, laminated object manufacturing, and/or fused deposition modelling.

39. The method method according to claim 37, wherein the first and second support portions are integrally formed by additive manufacturing.
